(19) United States
(12) Patent Application Publication
(10) Pub. No.: US 2026/0316824 A1
(43) Pub. Date: Oct. 15, 2026

(54) METHODS AND APPARATUS FOR SHARED STEERING CONTROL FOR VEHICLES

(71) Applicant: Ford Global Technologies, LLC, Dearborn, MI (US)

(72) Inventors: Akshay Bhardwaj, Detroit, MI (US); Ashrit Das, Canton, MI (US); Jens Dornhege, Pulheim (DE); Goetz-Philipp Wegner, Dortmund (DE); Lodewijk Wijffels, Northville, MI (US)

(21) Appl. No.: 19/177,216

(22) Filed: Apr. 11, 2025

(51) Int. Cl. B62D 6/00; B60W 30/10; B60W 30/12

(52) U.S. Cl. CPC B62D 6/002; B60W 30/10; B60W 30/12; B62D 6/007; B62D 6/008

(57) ABSTRACT

Methods and apparatus for shared steering control for vehicles are disclosed herein. An example vehicle disclosed herein includes a user interface, a driver-assistance system to generate a first reference angle, and a controller to determine an angle overlay based on an input to the user interface, determine an angle overlay limit based on the first reference angle, modify the angle overlay based on the angle overlay limit to generate a modified angle overlay, determine a second reference angle based on the modified angle overlay and the first reference angle, and control the vehicle based on the second reference angle. Some examples disclosed herein deactivate the driver-assistance system when the limit is exceeded.

This disclosure relates generally to vehicle control and, more particularly, to methods and apparatus for shared steering control for vehicles.

### BACKGROUND

In recent years, some vehicles have been outfitted with advanced driver-assistance systems (ADAS) that can assist a driver in the operation of a vehicle. Some ADAS are path follower systems that analyze the road around the vehicle and a target navigation path for the vehicle based on the analysis. Based on the determined navigation, a steering motor can apply torque to a steering system of the vehicle, which causes the vehicle to navigate along the determined path.

### SUMMARY

An example vehicle disclosed herein includes a user interface, a driver-assistance system to generate a first reference angle, and a controller to determine an angle overlay based on an input to the user interface, determine an angle overlay limit based on the first reference angle, modify the angle overlay based on the angle overlay limit to generate a modified angle overlay, determine a second reference angle based on the modified angle overlay and the first reference angle, and control the vehicle based on the second reference angle.

An example vehicle disclosed herein includes a user interface, a driver-assistance system to generate a first reference angle, and a controller to determine an angle overlay based on an input to the user interface, determine a reference angle limit based on the angle overlay, modify the first reference angle based on the reference angle limit to generate a second reference angle, determine a third reference angle based on the angle overlay and the second reference angle; and control the vehicle based on the third reference angle.

An example vehicle including a user interface, a driver-assistance system to generate a first reference angle, and a controller to determine an angle overlay based on an input to the user interface, determine a second reference angle based on the angle overlay and the first reference angle, determine a reference angle limit, modify the second reference angle based on the reference angle limit to generate a third reference angle, and control the vehicle based on the third reference angle.

### BRIEF DESCRIPTION OF THE DRAWINGS

FIG. 1 illustrates an example vehicle implemented in accordance with teachings of this disclosure.

FIG. 2 is a schematic diagram of an example steering system of the vehicle of FIG. 1.

FIG. 3 is a block diagram of the example steering controller of FIGS. 1 and 2.

FIG. 4A is a schematic system diagram of a first shared-control driving system including a first plurality of limiters implemented in accordance with teachings of this disclosure.

FIG. 4B is a schematic system diagram of a second shared-control driving system including a second plurality of limiters implemented in accordance with teachings of this disclosure.

FIG. 4C is a schematic system diagram of a third shared-control driving system including a third plurality of limiters implemented in accordance with teachings of this disclosure.

FIG. 5 is a first flowchart representative of example machine readable instructions and/or example operations that may be executed, instantiated, and/or performed by example programmable circuitry to implement the steering controller of FIG. 3 and/or the first shared-control driving system of FIG. 4A.

FIG. 6 is a second flowchart representative of example machine readable instructions and/or example operations that may be executed, instantiated, and/or performed by example programmable circuitry to implement the steering controller of FIG. 3 and/or the second shared-control driving system of FIG. 4B.

FIG. 7 is a third flowchart representative of example machine readable instructions and/or example operations that may be executed, instantiated, and/or performed by example programmable circuitry to implement the steering controller of FIG. 3 and/or the third shared-control driving system of FIG. 4C.

FIG. 8 is a block diagram of an example processing platform including programmable circuitry structured to execute, instantiate, and/or perform the example machine readable instructions and/or perform the example operations of FIGS. 5-7 to implement the steering controller of FIG. 3.

In general, the same reference numbers will be used throughout the drawing(s) and accompanying written description to refer to the same or like parts. The figures are not necessarily to scale.

### DETAILED DESCRIPTION

In recent years, advanced driver assistance systems (ADAS) for automobiles have become more common. As used herein, the acronym “ADAS” can refer to either a plurality of advanced driver assistance systems or a singular advanced driver assistance system, depending on the context of the sentence in which the acronym is used.

Some ADAS are path follower systems that generate a reference steering angle corresponding to a desired vehicle trajectory without active driver input. Some such ADAS are shared steering control systems, which enable a driver to have control over the vehicle trajectory without deactivating the ADAS. These systems enable a driver to affect (e.g., edit, change, modify, etc.) the trajectory of the vehicle via inputs to the steering wheel, which enables a driver to modify the operation of the ADAS without the deactivation thereof. Additionally, the control of the vehicle trajectory offered by shared steering control systems enhances the driving feel of the vehicle for drivers of the vehicle. An example shared-control ADAS is described in U.S. Patent Application No. 18/491,557, which is hereby incorporated by reference in its entirety. In some prior shared-control ADAS, the individual outputs of the driver-controlled system and the output of ADAS are bound. However, the combined output(s) of the shared steering control systems are not limited or bound. As a result, when the outputs of the driver-controlled system and the ADAS are associated with a steering response in a same direction, the combination thereof by the shared control driving experience can cause an unexpectedly large vehicle response. Such responses can diminish the driving experience for the driver.

Examples disclosed herein include limiters that limit the combined output(s) of shared-control steering systems. Examples disclosed herein include a shared control steering system that combines a reference angle output by an ADAS, and an angle overlay associated with an input of the driver. Some example shared control steering systems disclosed herein bound the angle overlay based on the reference angle outputs. Some example shared control steering systems disclosed herein bound the reference angle output based on the angle overlay. Some example shared control steering systems disclosed herein bound the combined output of the reference angle output and the angle overlay. Example shared control steering systems disclosed herein bound (e.g., limit, etc.) the combined output of shared control steering systems, which enhances the feel of the vehicle and the experience of the driver.

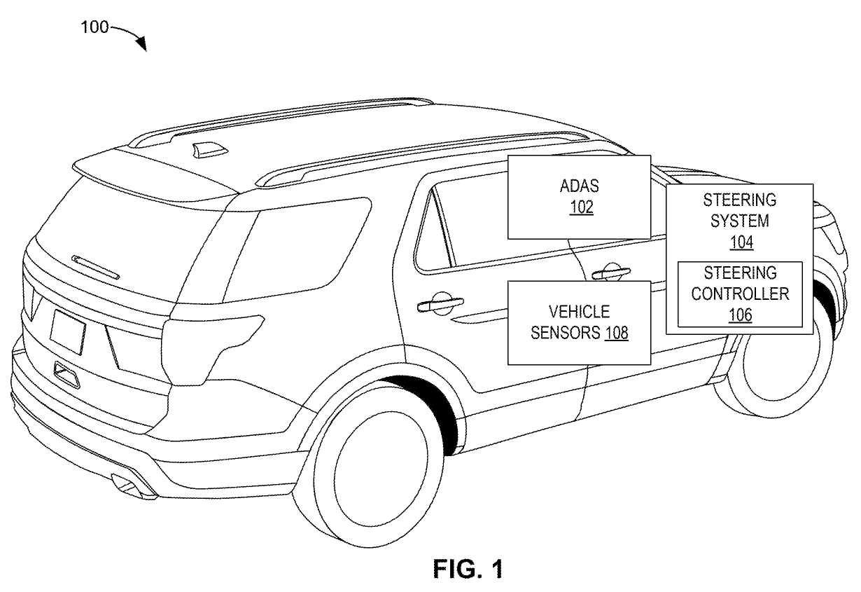

FIG. 1 illustrates an example vehicle 100 implemented in accordance with teachings of this disclosure. In the illustrated example of FIG. 1, the vehicle 100 includes an example ADAS 102, an example steering system 104, an example steering controller 106, and example vehicle sensors 108. The vehicle 100 is a motorized wheel-driven vehicle. In the illustrated example of FIG. 1, the vehicle 100 is a sport utility vehicle (SUV). In other examples, the vehicle 100 can be any type of wheeled vehicle (e.g., a sedan, a coupe, a van, a pick-up, an all-terrain vehicle (ATV), farming equipment, etc.). In some examples, the vehicle 100 includes an internal combustion engine (e.g., a non-electrified vehicle, a partially electrified vehicle, a hybrid, etc.). In other examples, the vehicle 100 is a fully electric vehicle.

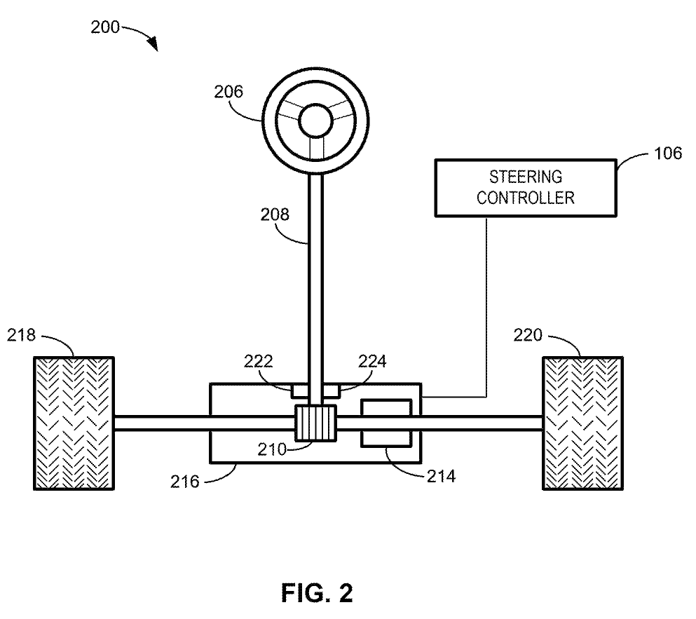

The steering system 104 allows a driver of the vehicle 100 to control/steer the vehicle 100. In some examples, the steering system 104 includes a mechanical linkage between a user interface of the vehicle 100 (e.g., a steering wheel, etc.) and the wheels of the vehicle 100 (e.g., via a steering column and rack and pinion system, etc.). For example, the steering system 104 can include an electric-powered steering system. In other examples, the steering system 104 can include any suitable type of powered steering and/or steering assist (e.g., hydraulic, hybrid electro-hydraulic systems, etc.). Additionally or alternatively, the steering system 104 can include other mechanisms (e.g., external angle controllers (EAC), one or more actuators, etc.) that interface with the ADAS 102 and/or the steering controller 106 and enable the navigation direction of the vehicle 100 to be adjusted without direct input from the driver. In some examples, the steering system 104 is a steer-by-wire system and/or a partially steer-by-wire system. An example implementation of the steering system 104 is described below in conjunction with FIG. 2.

The ADAS 102 interfaces with the systems of the vehicle 100 and/or the steering controller 106 to assist with the steering of the vehicle 100 and/or direct the vehicle along a target path. In some examples, the ADAS 102 is a level 2 ADAS and/or a level 3 ADAS. In some such examples, the ADAS 102 is a path follower (PF) system. As used herein, the vehicle 100 is in “a driver assist mode” when the ADAS 102 is active. In some examples, the ADAS 102 can be activated and deactivated by an operator of the vehicle 100 interfacing with a user interface of the vehicle 100 (e.g., a dash-display, a button, a switch, a microphone, etc.) and/or a personal device of the operator (e.g., a smartphone, a smartwatch, etc.). While the vehicle 100 is in a driver assist mode, the ADAS 102 generates a reference angle to direct the vehicle 100 along a target path. References angles generated by the ADAS 102 are also referred to herein as “path follower angle requests” and “reference navigation angles.” In some examples, the reference angle generated by the ADAS 102 is based on the destination of the vehicle 100, a position of the vehicle 100 (e.g., where the vehicle 100 is within a lane, etc.) and the ambient conditions of the vehicle 100 (e.g., the presence of other vehicles, pedestrians, and/or obstacles, the road the vehicle 100 is operating on, weather conditions, etc.) and is otherwise independent of driver input.

The steering controller 106 regulates and/or controls the operation of the steering system 104 of the vehicle 100. In some examples, the steering controller 106 receives input from a user interface of the vehicle 100 (e.g., a steering wheel of the vehicle 100, etc.). In some examples, when the ADAS 102 is active (e.g., the ADAS 102 is generating a reference angle, the vehicle 100 is in a driver assist mode, etc.), the steering controller 106 can generate an angle overlay based on the input to the user interface of the steering system 104. As used herein, the phrases “angle overlay” and “boost curve” are used interchangeably to refer to the driver-related input to a shared-control ADAS.

In some examples, the steering controller 106 combines the angle overlay with the reference angle output by the ADAS 102 to generate a shared control reference angle, which is then applied to the steering system 104 to steer the vehicle 100. In some examples, the combination of the reference angle and the angle overlay enables the driver to have control over the vehicle 100 without deactivating the ADAS 102. In some examples, the steering controller 106 generates limits for the angle overlay, the reference angle, and/or the shared-control reference angle. For example, the steering controller 106 bounds the angle overlay, the reference angle, and/or the shared-control reference angle based on a performance requirement for the vehicle 100 (e.g., a controllability of the vehicle 100, etc.), a torque input to a steering wheel of the vehicle 100, and/or the speed of the vehicle 100. In some examples, the steering controller 106 bounds the angle overlay, the reference angle, and/or the combined automation angle with a rate limit and/or a magnitude limit.

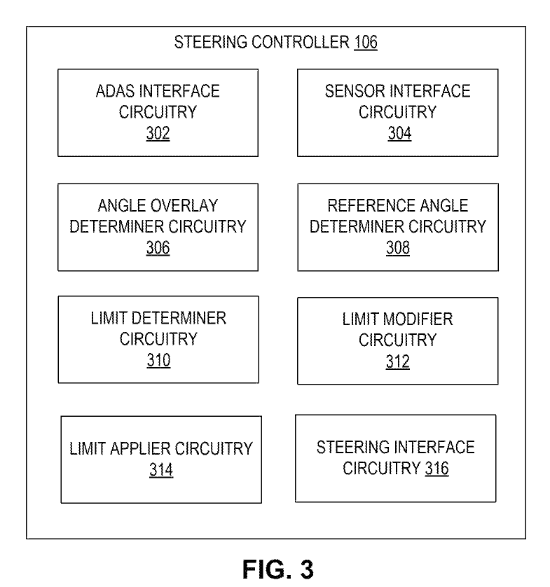

In some examples, the steering controller 106 modifies a limit determined for the reference angle based on the angle overlay prior to combining the angle overlay and the reference angle. Additionally or alternatively, the steering controller 106 modifies a limit determined for the angle overlay based on the reference angle prior to combining the angle overlay and the reference angle. An example implementation of the steering controller 106 is described below in conjunction with FIG. 3. In some examples, some or all of the steering controller 106 can be implemented by an electronic control unit (ECU) of the vehicle 100. Additionally or alternatively, some or all of the steering controller 106 can be implemented by another suitable computer (e.g., another computer of the vehicle 100, a mobile device of a user of the vehicle 100, a remote computer, etc.).

The vehicle sensors 108 include one or more sensors that measure different metrics related to the vehicle 100. For example, the vehicle sensors 108 can measure metrics related to the steering system 104, such as the position of a steering wheel, a speed of the steering wheel, a torque applied to the steering wheel, a position of the steering system (e.g., a position of the steering rack and pinion, etc.), system parameters related to the power steering system, etc. In some examples, the vehicle sensors 108 can include one or more speedometers that enable a speed of the vehicle 100 to be determined. In some examples, the steering controller 106 interfaces with the vehicle sensors 108 to receive the sensor outputs thereof.

FIG. 2 is a schematic of an example steering system 200 of the example vehicle 100 of FIG. 1. The steering system 200 of FIG. 2 can implement the steering system 104 of FIG. 1. In other examples, the steering system 104 of FIG. 1 can be implemented by a different type of steering system (e.g., a different type of mechanical steering system, a steer-by-wire system, etc.). In the illustrated example of FIG. 2, the steering system 200 includes an example steering wheel 206, an example steering column 208, an example steering gear 210, an example steering motor 214, an example housing 216, an example first steered wheel 218, an example second steered wheel 220, an example steering torque sensor 222, and an example steering wheel angle sensor 224.

The steering wheel 206 is a user interface that enables a driver of the vehicle 100 to interface with the steering system 104. In the illustrated example of FIG. 2, the steering wheel 206 is coupled to the steered wheels 218, 220 via the steering column 208 and the steering gear 210. The steering column 208 is a shaft that mechanically couples the steering wheel 206 to the steering gear 210. In the illustrated example of FIG. 2, the steering column 208 is a single shaft that extends between the steering wheel 206 and the steering gear 210. In other examples, the steering column 208 includes two or more interconnected shafts. In some such examples, the steering column 208 can include a first steering shaft coupled to a second steering shaft via a universal joint (U-joint).

The steering gear 210 is an actuator, which translates rotational inputs from the steering column 208 into motion of the steered wheels 218, 220. As the driver applies torque to the steering wheel 206, the steering gear 210 rotates and provides a linear force via the linkages coupled to the steered wheels 218, 220. In some examples, the steering gear 210 is a rack and pinion steering system. In other examples, the steering gear 210 can be implemented by another type of steering system (e.g., a recirculating ball steering gear, a worm and sector steering gear, a worm and nut steering gear, etc.). In some examples, the steering gear 210 has a fixed gear ratio. In other examples, the steering gear 210 has a variable gear ratio. In some examples, the steering gear 210 is mounted to a frame and/or a body of the vehicle 100.

The steered wheels 218, 220 are the wheels of the vehicle 100 that are moveably coupled to the steering system 200. In the illustrated example of FIG. 2, the steered wheels 218, 220 are the front wheels of the vehicle 100 (e.g., the first steered wheel 218 is the front passenger side wheel, the second steered wheel 220 is the front driver side wheel, etc.). In other examples, the steered wheels 218, 220 are the rear wheels of the vehicle.

The steering motor 214 applies torque to the steering system 200. In the illustrated example of FIG. 2, the steering motor 214 is coupled to the steering gear 210 and is disposed within the housing 216. In other examples, the steering motor 214 is disposed at another location of the steering system 200 (e.g., outside of the housing 216, on the steering column 208, etc.) During operation, the steering motor 214 applies a torque to the steering gear 210, which correspondingly moves the steering wheel 206 and the steered wheels 218, 220. In the illustrated example of FIG. 2, the ADAS 102 and/or the steering controller 106 can operate the steering motor 214 to adjust the steering angle of the steering wheel 206 and the road wheel angle of the first steered wheel 218 and second steered wheel 220 to steer the vehicle 100.

In the illustrated example of FIG. 2, the steering motor 214 is an independent device. In other examples, the steering motor 214 can be a component of the power steering system of the vehicle 100. In such examples, the steering motor 214 can provide power steering assistance to the steering system 200. For example, during conventional operation of the vehicle 100 (e.g., when the vehicle 100 is not in a driver assist mode, etc.), the steering controller 106 can operate the steering motor 214 to provide additional torque assistance for steering the vehicle 100 based on the torque applied to the steering wheel 206. Additionally or alternatively, the steering controller 106 and/or the ADAS 102 can operate the steering motor 214 to control the steering angle of the steering wheel 206 while the vehicle 100 is in a driver assist mode. For example, the steering controller 106 can provide a reference angle and/or a torque request to the steering motor 214 to cause the steering motor 214 to adjust a position of the steered wheels 218, 220 and/or the steering wheel 206.

The steering torque sensor 222 measures the steering torque applied to the steering column 208. In the illustrated example of FIG. 2, the steering torque sensor 222 is disposed near the bottom of the steering column 208. In other examples, the steering torque sensor 222 can be coupled to an upper portion of the steering column 208. The steering torque sensor 222 measures the torque exerted by the driver on the steering system 200. In some examples, the steering torque sensor 222 can be implemented by any suitable means of measuring applied torque (e.g., a magnetoelastic torque sensor, a rotary strain gauge, etc.). Additionally or alternatively, the steering torque may be derived from any other suitable measurable quantities. As used herein, the raw output of the steering torque sensor 222 is referred as the input steering torque. As used herein, the filtered and/or processed output of the steering torque sensor 222 is referred to as the driver torque estimate. In some examples, the output of the steering torque sensor 222 (e.g., the input steering torque, etc.) can be filtered via a Kalman filter to generate the driver torque estimate.

The steering wheel angle sensor 224 measures the rotational position of the steering wheel 206. In the illustrated example of FIG. 2, the steering wheel angle sensor 224 is disposed adjacent to the steering gear 210. Additionally or alternatively, the steering wheel angle sensor 224 can be disposed on the steering column 208. The steering wheel angle sensor 224 can be implemented by any suitable means of measuring steering angle (e.g., a rotary encoder, an optical encoder, a Hall-effect sensor, a resolver, a magnetic sensor, etc.). Additionally or alternatively, the steering angle may be derived from other metrics (e.g., steering velocity, steering acceleration, steering torque, etc.). Additionally or alternatively the steering angle may be derived from a position of the steering motor 214 (e.g., an angular measurement of the steering motor 214 from a sensor associated therewith, etc.).

FIG. 3 is a block diagram of an example implementation of the steering controller 106 of FIG. 1 to generate and modify (e.g., limit, bound, etc.) a limit to a reference angle, a shared control reference angle, and/or an angle overlay and apply a torque request to the steering system 200 of FIG. 2. In the illustrated example of FIG. 3, the steering controller 106 includes example ADAS interface circuitry 302, example sensor interface circuitry 304, example angle overlay determiner circuitry 306, example reference angle determiner circuitry 308, example limit determiner circuitry 310, example limiter modified circuitry 312, example limit applier circuitry 314, and example steering interface circuitry 316. The steering controller 106 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the steering controller 106 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers. In some examples, some or all of the processes associated with the steering controller 106 can be executed by other systems of the vehicle 100 and/or one or more compute devices associated with a user thereof, such as the ADAS 102 of FIG. 1.

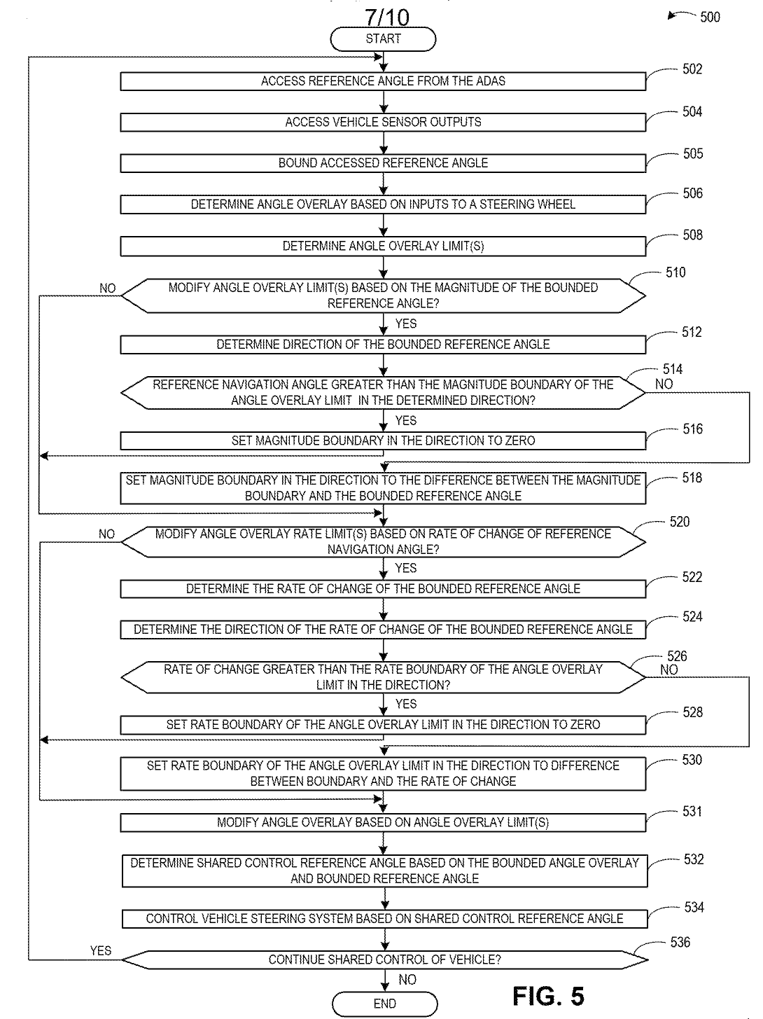

The ADAS interface circuitry 302 interfaces with the ADAS 102 of FIG. 1. For example, the ADAS interface circuitry 302 can access a reference angle from vehicle navigation from the ADAS 102. In some examples, the ADAS interface circuitry 302 interfaces with the ADAS 102 via one or more wireless and/or wired connections (e.g., via a controller area network (CAN) bus of the vehicle 100, etc.). In some examples, the ADAS interface circuitry 302 can send sensor data accessed via the sensor interface circuitry 304 to the ADAS 102 to enable the generation of the reference angle. In some examples, the ADAS interface circuitry 302 is instantiated by programmable circuitry executing ADAS interface instructions and/or configured to perform operations such as those represented by the flowcharts of FIGS. 5-7.

The sensor interface circuitry 304 accesses (e.g., requests, receives, etc.) sensor data from the sensors of the example vehicle 100 and the steering system 104. For example, the sensor interface circuitry 304 can receive input from the steering torque sensor 222, the steering wheel angle sensor 224, and/or the vehicle sensors 108 (e.g., a speedometer of the vehicle 100, etc.) via one or more wireless and/or wired connections (e.g., via a CAN bus of the vehicle 100, etc.). In some examples, the sensor interface circuitry 304 distributes received sensor data to at least one of the ADAS interface circuitry 302, the angle overlay determiner circuitry 306, the reference angle determiner circuitry 308, the limit determiner circuitry 310, the limit modifier circuitry 312, the limit applier circuitry 314, and/or the steering interface circuitry 316. In some examples, the sensor interface circuitry 304 is instantiated by programmable circuitry executing sensor interface instructions and/or configured to perform operations such as those represented by the flowcharts of FIGS. 5-7.

The angle overlay determiner circuitry 306 determines an angle overlay based on a driver input. For example, the angle overlay determiner circuitry 306 can determine an angle overlay via the process described in conjunction with FIGS. 9-15 of U.S. Patent Application No. 18/491,557. Additionally or alternatively, the angle overlay determiner circuitry 306 can determine the angle overlay via sensor data accessed by the sensor interface circuitry 304. In some such examples, the angle overlay determiner circuitry 306 can determine the angle overlay via the steering wheel angle, the steering wheel torque, and/or one or other sensor outputs accessed by the sensor interface circuitry 304. In some examples, the angle overlay determiner circuitry 306 is instantiated by programmable circuitry executing angle overlay determiner instructions and/or configured to perform operations such as those represented by the flowcharts of FIGS. 5-7.

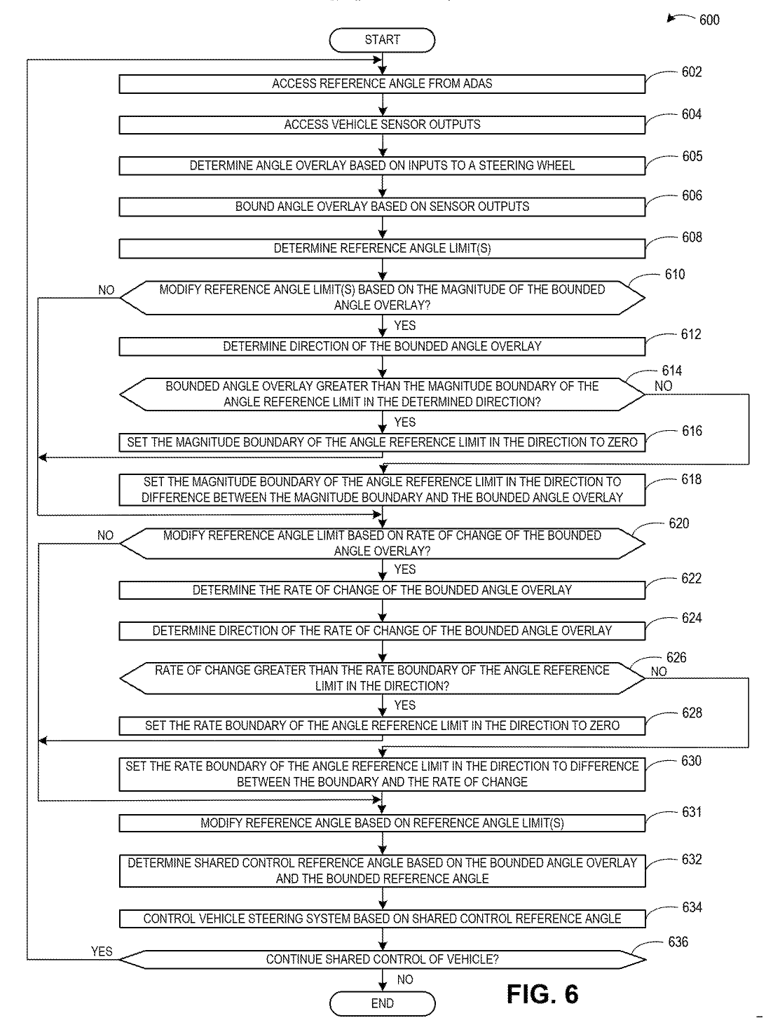

The reference angle determiner circuitry 308 determines a shared-control reference angle for navigation of the vehicle 100 based on the angle overlay determined by the angle overlay determiner circuitry 306 and the reference angle accessed by the ADAS interface circuitry 302 of FIG. 3. For example, the reference angle determiner circuitry 308 can determine the new reference angle via the process described in conjunction with FIG. 6 of U.S. Patent Application No. 18/491,557. In other examples, the reference angle determiner circuitry 308 can determine the new reference angle in any other suitable manner. In some examples, the reference angle determiner circuitry 308 is instantiated by programmable circuitry executing reference angle determiner instructions and/or configured to perform operations such as those represented by the flowcharts of FIGS. 5-7.

The limit determiner circuitry 310 determines one or more limits for the outputs of the ADAS interface circuitry 302, the angle overlay determiner circuitry 306, and/or the reference angle determiner circuitry 308. For example, the limiter determiner circuitry 310 can determine a magnitude and/or a rate limit for the angle overlay determined by the angle overlay determiner circuitry 306 (e.g., an angle overlay limit, etc.). For example, the limiter determiner circuitry 310 can determine an angle overlay limit based on a speed of the vehicle 100 and/or an activity level of a driver of the vehicle 100 (e.g., an input torque, an estimated driver torque, a presence of the driver’s hands on the steering wheel 206 of FIG. 2, etc.). Additionally or alternatively, the limiter determiner circuitry 310 can determine a magnitude and/or a rate limit for the reference angle accessed by the ADAS interface circuitry 302 (e.g., a reference navigation angle limit, etc.). As used herein, the limits determined by the limit determiner circuitry 310 have a positive boundary and a negative boundary, which correspond to the maximum permitted rate of change and/or magnitude in the left direction and/or the right direction.

Additionally or alternatively, the limit determiner circuitry 310 can determine a magnitude or rate limit for the shared control reference angle determined by the reference angle determiner circuitry 308 (e.g., a shared control reference angle limit, etc.). In some examples, the limit determiner circuitry 310 can determine the limit for the shared control reference angle based on the speed of the vehicle and/or the dynamics of the vehicle 100 (e.g., location of the center mass of the vehicle 100, the weight distribution of the vehicle 100, etc.). For example, the limit determiner circuitry 310 can determine a limit based on a controllability of the vehicle 100 at a given speed. In some examples, the controllability of the vehicle 100 is determined via testing (e.g., assessing if a vehicle 100 remains in a lane during testing, etc.), analytically (e.g., based on the dynamics of the vehicle 100, based on the steering behavior of the vehicle 100, etc.), and/or based on a user preference. In some examples, the limiter determiner circuitry 310 is instantiated by programmable circuitry executing limiter determiner instructions and/or configured to perform operations such as those represented by the flowcharts of FIG. 5-7.

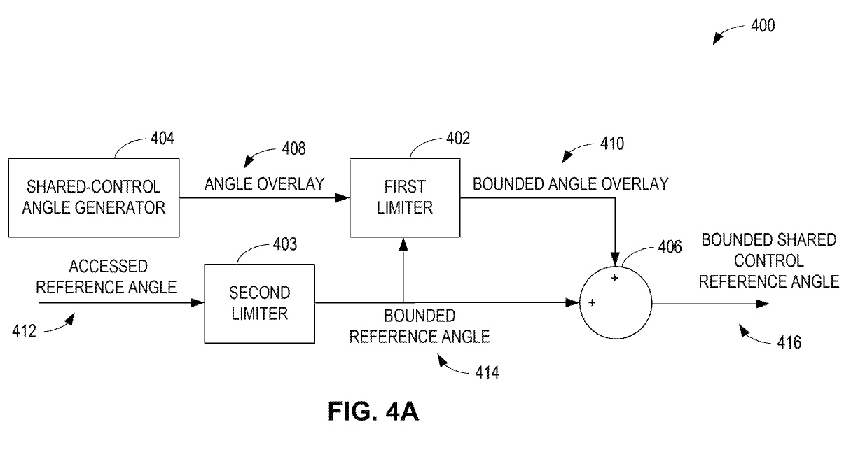

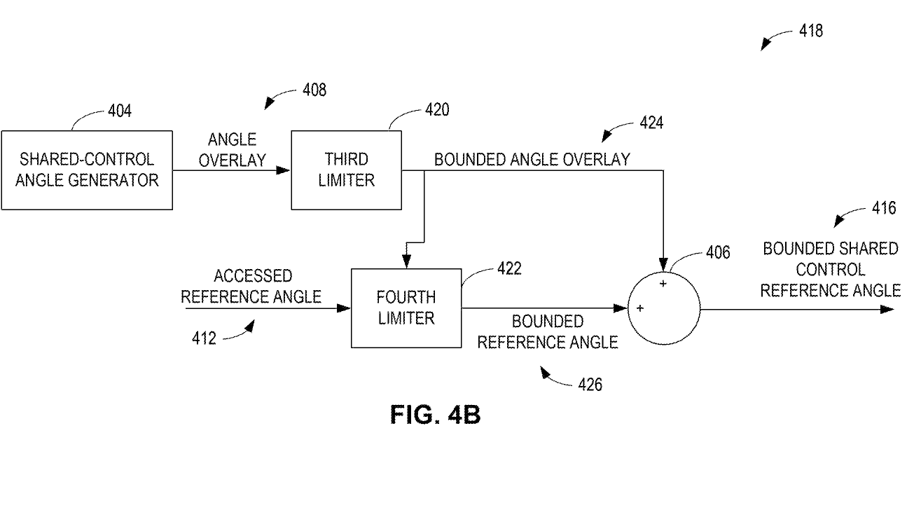

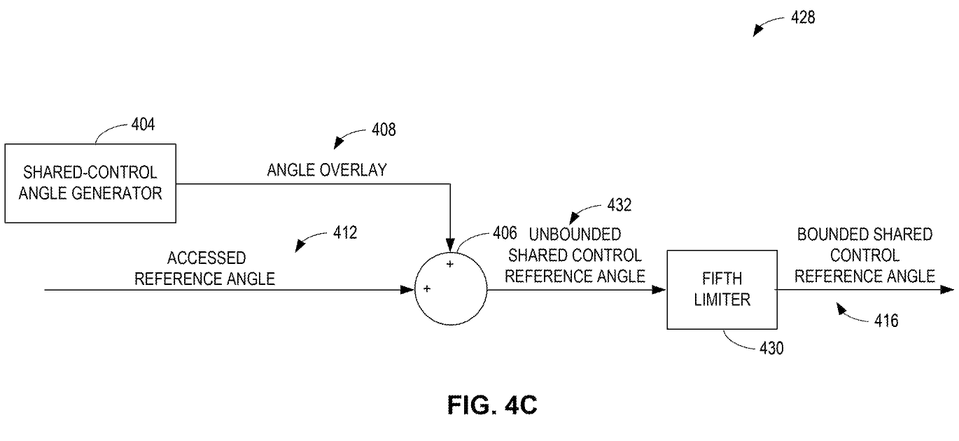

The limit modifier circuitry 312 modifies the limit(s) determined by the limit determiner circuitry 310. For example, the limit modifier circuitry 312 can modify a boundary of a limit for the angle overlay based on the accessed reference angle. Additionally or alternatively, the limit modifier circuitry 312 can determine a limit for the accessed reference angle based on the angle overlay. The operation of the limit modifier circuitry 312 is described below in additional detail in conjunction with FIGS. 4A-4C. In some examples, the limit modifier circuitry 312 is instantiated by programmable circuitry executing limiter determiner instructions and/or configured to perform operations such as those represented by the flowcharts of FIG. 5-7.

The limiter applier circuitry 314 applies the limits determined by the limit determiner circuitry 310 and/or the limit modifier circuitry 312 to the output(s) of the ADAS interface circuitry 302, the angle overlay determiner circuitry 306, and/or reference angle determiner circuitry 308.In some examples, the limiter applier circuitry 314 applies a rate limit to the output(s) of the accessed reference angle, the angle overlay, and/or the shared control reference angle to limit the rate of change thereof. Additionally or alternatively, the limiter applier circuitry 314 can apply a magnitude limit to the accessed reference angle, the angle overlay, and/or the shared control reference angle (e.g., only a magnitude limit, both a rate limit and a magnitude limit, etc.). In some examples, the limiter applier circuitry 314 is instantiated by programmable circuitry executing limiter applier instructions and/or configured to perform operations such as those represented by the flowcharts of FIGS. 5-7. In some examples, the limiter applier circuitry 314 is instantiated by programmable circuitry executing limiter applier instructions and/or configured to perform operations such as those represented by the flowcharts of FIGS. 5-7.

The steering interface circuitry 316 controls the vehicle steering system based on the new reference angle determined by the reference angle determiner circuitry 308. For example, the steering interface circuitry 316 can convert the new reference angle into a torque request based on the current position of the steering gear 210. In some such examples, the steering interface circuitry 316 can determine the torque request based on analytic calculations, a relationship curve, and/or a look-up table. In some examples, the steering interface circuitry 316 can cause the steering motor 214 to apply a torque to the steering gear 210 to cause a corresponding change in vehicle navigation based on the new reference angle determined by the reference angle determiner circuitry 308. In some examples, the steering interface circuitry 316 is instantiated by programmable circuitry executing reference steering interface instructions and/or configured to perform operations such as those represented by the flowcharts of FIGS. 5-7.

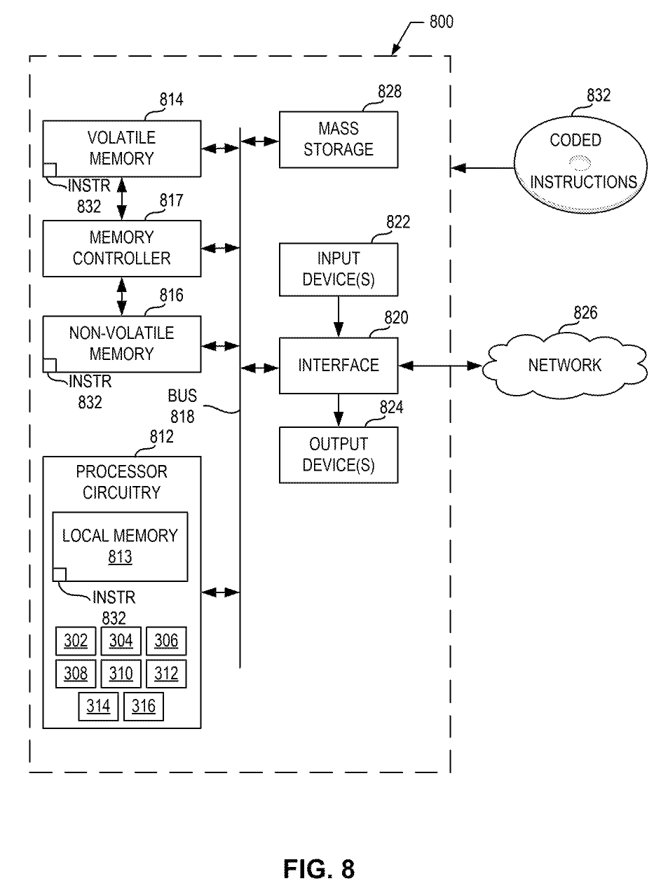

In some examples, the steering controller 106 includes means for interfacing with one or more sensors, means for interfacing with an ADAS of a vehicle, means for determining an angle overlay, means for determining a reference angle, means for determining a limit, means for modifying a limit, means for applying a limit, and/or means for interfacing with a steering system. For example, the means for interfacing with an ADAS of a vehicle may be implemented by the ADAS interface circuitry 302, the means for interfacing with one or more sensors may be implemented by the sensor interface circuitry 304, the means for determining an angle overlay may be implemented by the angle overlay determiner circuitry 306, the means for determining a reference angle may be implemented by the reference angle determiner circuitry 308, the means for determining a limit may be implemented by the limiter determiner circuitry 310, the means for modifying a limit may be implemented by the limiter modifier circuitry 312, the means for applying a limit may be implemented by the limiter applier circuitry 314, and/or the means for interfacing with a steering system may be implemented by the steering interface circuitry 316. In some examples, the steering interface circuitry 316 may be instantiated by programmable circuitry such as the example programmable circuitry 812 of FIG. 8. In some examples, the ADAS interface circuitry 302, the sensor interface circuitry 304, the angle overlay determiner circuitry 306, the reference angle determiner circuitry 308, the limit determiner circuitry 310, the limit modifier circuitry 312, the limit applier circuitry 314, and/or the steering interface circuitry 316 may be instantiated by hardware logic circuitry, which may be implemented by an ASIC, XPU, or FPGA circuitry configured and/or structured to perform operations corresponding to the machine readable instructions. Additionally or alternatively, the ADAS interface circuitry 302, the sensor interface circuitry 304, the angle overlay determiner circuitry 306, the reference angle determiner circuitry 308, the limit determiner circuitry 310, the limit modifier circuitry 312, the limit applier circuitry 314, and/or the steering interface circuitry 316 may be instantiated by any other combination of hardware, software, and/or firmware. For example, the ADAS interface circuitry 302, the sensor interface circuitry 304, the angle overlay determiner circuitry 306, the reference angle determiner circuitry 308, the limit determiner circuitry 310, the limit modifier circuitry 312, the limit applier circuitry 314, and/or the steering interface circuitry 316 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the steering controller 106 of FIG. 1 is illustrated in FIG. 3, one or more of the elements, processes, and/or devices illustrated in FIG. 3 may be combined, divided, re-arranged, omitted, eliminated, and/or implemented in any other way. Further, the ADAS interface circuitry 302, the sensor interface circuitry 304, the angle overlay determiner circuitry 306, the reference angle determiner circuitry 308, the limit determiner circuitry 310, the limit modifier circuitry 312, the limit applier circuitry 314, the steering interface circuitry 316, and/or, more generally, the example steering controller 106 of FIG. 3, may be implemented by hardware alone or by hardware in combination with software and/or firmware. Thus, for example, any of the ADAS interface circuitry 302, the sensor interface circuitry 304, the angle overlay determiner circuitry 306, the reference angle determiner circuitry 308, the limit determiner circuitry 310, the limit modifier circuitry 312, the limit applier circuitry 314, the steering interface circuitry 316, and/or, more generally, the example steering controller 106, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example steering controller 106 of FIG. 3 may include one or more elements, processes, and/or devices in addition to, or instead of, those illustrated in FIG. 3, and/or may include more than one of any or all of the illustrated elements, processes and devices.

FIG. 4A is a schematic system diagram of an example first shared-control steering system 400 including an example first limiter 402 and an example second limiter 403 implemented in accordance with teachings of this disclosure. In the illustrated example of FIG. 4A, the first shared-control steering system 400 includes an example shared-control angle generator 404 and an example combiner 406. In the illustrated example of FIG. 4A, the shared-control angle generator 404 generates an example angle overlay 408, which is input into the first limiter 402. In the illustrated example of FIG. 4A, an accessed reference angle 412 (e.g., a first reference angle, etc.) is input into the second limit 403, which generates an example bounded reference angle 414 (e.g., a second reference angle, etc.). In the illustrated example of FIG. 4A, the first limiter 402 generates an example bounded angle overlay 410 (e.g., a modified angle overlay, a second angle overlay, etc.) based on the angle overlay 408 and the bounded reference angle 414. The example combiner 406 combines the bounded angle overlay 410 and the bounded reference angle 414 to generate an example bounded shared-control reference angle 416 (e.g., a third reference angle, etc.).

The shared-control angle generator 404 generates the angle overlay 408. For example, the shared-control angle generator 404 can generate the angle overlay 408 based on a position of the steering wheel 206 (e.g., the output of the steering wheel angle sensor 224 of FIG. 2, etc.), the torque applied to the steering wheel 206 (e.g., the output of the steering torque sensor 222 of FIG. 2, etc.), the ambient conditions of the vehicle 100, and/or any other inputs. In some examples, the angle overlay 408 generated by the shared-control angle generator 404 is positive (e.g., corresponding to leftward navigation of the vehicle 100 and counterclockwise rotation of the steering wheel 206, etc.) or negative (e.g., corresponding to rightward navigation of the vehicle 100 and clockwise rotation of the steering wheel 206, etc.). In some examples, the shared-control angle generator 404 can be implemented by the angle overlay determiner circuitry 306 of FIG. 3.

The accessed reference angle 412 is the unmodified output of the ADAS 102 of FIG. 1 and corresponds to the navigation direction determined thereby. For example, the ADAS 102 can determine the accessed reference angle 412 based on the current settings of the vehicle 100, the ambient conditions of the vehicle 100, a user preference, and/or any other suitable characteristics. The accessed reference angle 412 is also referred to herein as the “ADAS angle,” the “ADAS reference angle” and the “unmodified reference angle.” Like the angle overlay 408, the accessed reference angle 412 can be positive (e.g., corresponding to leftward navigation of the vehicle 100 and counterclockwise rotation of the steering wheel 206, etc.) or negative (e.g., corresponding to rightward navigation of the vehicle 100 and clockwise rotation of the steering wheel 206, etc.). In some examples, the accessed reference angle 412 is generated by the ADAS 102 and is accessed by the ADAS interface circuitry 302 of FIG. 3.

The first limiter 402 modifies (e.g., limits, bounds, etc.) the angle overlay 408 to generate the bounded angle overlay 410. In some examples, the first limiter 402 can determine limits for the angle overlay 408 based on the speed of the vehicle 100 and/or the activity level of a driver (e.g., the presence of a driver’s hands on the steering wheel 206, a torque applied to the steering wheel 206, etc.). In the illustrated example of FIG. 4A, the limits determined by the first limiter 402 are modified based on the bounded reference angle 414. In other examples, the limits determined by the limiter 402 are modified based on the accessed reference angle 412. In some examples, the first limiter 402 can limit the rate of change and/or the magnitude of the angle overlay 408. In some examples, the first limiter 402 can be implemented by the limit determiner circuitry 310 of FIG. 3, the limit modifier circuitry 312 of FIG. 3, and/or the limit applier circuitry 314 of FIG. 3.

In some examples, the first limiter 402 determines a rate limit and applies the rate limit to the angle overlay 408. In some examples, the first limiter 402 modifies the determined rate limit based on the bounded reference angle 414. In some examples, the first limiter 402 determines a rate of change (e.g., a derivative, etc.) of the bounded reference angle 414. In some examples, the first limiter 402 filters the determined rate of change to smooth the bounded reference angle 414 and/or to prevent discontinuities in the bounded reference angle 414. In some examples, the first limiter 402 determines the direction (e.g., positive, negative, etc.) of the rate of change of the bounded reference angle 414. In some such examples, the first limiter 402 determines if the rate of change of the bounded reference angle 414 is greater than a boundary of the rate limit in the determined direction. If the rate of change of the bounded reference angle 414 is greater than the boundary of the rate limit in the determined direction (e.g., the rate limit is saturated, etc.), the first limiter 402 sets the boundary of the rate limit in the determined direction to a pre-set value (e.g., zero, etc.). If the rate of change of the bounded reference angle 414 is less than the boundary of the rate limit in the determined direction (e.g., the rate limit is saturated, etc.), the first limiter 402 sets the boundary of the rate limit in the determined direction to a difference between the boundary and the bounded reference angle 414. For example, if the rate limit has a -5 degree per second boundary in both the left and right directions and the derivative of the bounded reference angle 414 is -7 degrees per second, the first limiter 402 sets the rate limit boundary in the right direction to 0 degrees per second. Similarly, if the rate limit has a 5 degrees per second boundary in both the left and right directions and the derivative of the bounded reference angle 414 is 1 degree per second, the first limiter 402 sets the rate limit boundary in the left direction to 4 degrees per second. Additionally or alternatively, the first limiter 402 determines a magnitude limit based on the bounded reference angle 414 and applies the magnitude limit to angle overlay 408. In some examples, the first limiter 402 modifies the determined magnitude limit based on the bounded reference angle 414. In some examples, the first limiter 402 determines the direction (e.g., positive, negative, etc.) of the bounded reference angle 414. In some such examples, the first limiter 402 determines if the bounded reference angle 414 is greater than the boundary of the magnitude limit in the determined direction. If the bounded reference angle 414 is greater than the boundary of the magnitude limit in the determined direction (e.g., the magnitude limit is saturated, etc.), the first limiter 402 sets the boundary of the magnitude limit in the determined direction to a pre-set value (e.g., zero, etc.). If the bounded reference angle 414 is less than the boundary of the magnitude limit in the determined direction (e.g., the magnitude limit is saturated, etc.), the first limiter 402 sets the boundary of the magnitude limit in the determined direction to a difference between the boundary and the bounded reference angle 414. For example, if the magnitude limit has a 30 degree boundary in both the left and right directions and the bounded reference angle 414 is 45 degrees, the first limiter 402 sets the magnitude limit boundary in the left direction to 0 degrees. Similarly, if the rate limit has a 50 degree boundary in both the left and right directions and the derivative of the bounded reference angle 414 is -45 degrees, the first limiter 402 sets the rate limit boundary in the right direction to -5 degrees.

The second limiter 403 receives the accessed reference angle 412 and outputs the bounded reference angle 414. For example, the second limiter 403 determines one or more limit(s) (e.g., a rate limit, a magnitude limit, etc.) and applies the determined limits to the accessed reference angle 412 to generate the bounded reference angle 414. For example, the second limiter 403 can determine a limit for the accessed reference angle 412 based on a torque applied to the steering wheel 206, a speed of the vehicle 100, the dynamic properties of the vehicle 100 (e.g., the weight distribution, the center of mass, a suspension characteristic of the vehicle 100, etc.). Additionally or alternatively, the second limiter 403 can determine a limit for the accessed reference angle 412 based on testing (e.g., testing the controllability of a vehicle for a given accessed reference angle 412 and/or the rate of change thereof, etc.). After determining the limits, the second limiter 403 compares the accessed reference angle 412 (e.g., the magnitude of the accessed reference angle 412, the rate of change of the accessed reference angle 412, etc.) and limits the accessed reference angle 412 if the accessed reference angle exceeds the determined limits.

The combiner 406 combines the bounded reference angle 414 and the bounded angle overlay 410 to generate the bounded shared-control reference angle 416. In some examples, the combiner 406 can combine the bounded reference angle 414 and the bounded angle overlay 410 via the additive process described in conjunction with FIG. 6 of U.S. Patent Application No. 18/491,557. In other examples, the combiner 406 can combine the bounded reference angle 414 and the bounded angle overlay 410 to generate the bounded shared-control reference angle 416 in any other suitable manner (e.g., a weighted average, multiplying, subtracting, etc.). The bounding of the angle overlay 408 based on the bounded reference angle 414 prevents unexpected values for the bounded shared-control reference angle 416. For example, if the bounded angle overlay 410 and the bounded reference angle 414 had the same direction, the combination of the bounded angle overlay 410 and the bounded reference angle 414 could result in a shared-control reference angle that exceeds a controllability limit even though both the angle overlay 408 and the accessed reference angle 412 were bounded. Similarly, if the rate of change of the bounded angle overlay 410 and the rate of change of the bounded reference angle 414 had the same direction, the combination of the bounded angle overlay 410 and the bounded reference angle 414 could result in a rate of change in the shared-control reference angle that exceeds a controllability limit even though both the rate of change of the angle overlay 408 and the rate of change of accessed reference angle 412 were bounded. Modifying the angle overlay limits determined by the first limiter 402 based on the bounded reference angle 414 prevents such unexpectedly large values of the bounded shared-control reference angle 416. That is, by setting the boundaries of the limits in the determined direction to a difference between the boundary and the bounded angle overlay 424 and/or the rate of change thereof or zero, the addition of the bounded angle overlay 410 and the bounded reference angle 414 prevents the bounded shared-control reference angle 416 for exceeding an overall controllability limit for the bounded shared-control reference angle 416 and/or the rate of change thereof.

The bounded shared-control reference angle 416 is also referred to herein as the “new reference angle,” the “modified reference angle,” and the “combined reference angle.” In some examples, the bounded shared-control reference angle 416 can be used to determine a torque request for the steering motor 214 of the steering system 200 of FIG. 2, which is used to operate the steering gear 210 of FIG. 2 to achieve the navigation of the vehicle 100 associated with the bounded shared-control reference angle 416. In some examples, the combiner 406 can be implemented by the angle overlay determiner circuitry 306 of FIG. 3.

FIG. 4B is a schematic system diagram of an example second shared-control steering system 418. The second shared-control steering system 418 is similar to the first shared-control steering system 400, except that the second shared-control steering system 418 includes an example third limiter 420 and an example fourth limiter 422. In the illustrated example of FIG. 4B, the second shared-control steering system 418 includes the shared-control angle generator 404 of FIG. 4A and the combiner 406 of FIG. 4A, which generate the angle overlay 408 of FIG. 4A and the bounded shared-control reference angle 416 of FIG. 4A, respectively.

In the illustrated example of FIG. 4B, the third limiter 420 generates an example bounded angle overlay 424. The third limiter 420 is similar to the first limiter 402 of FIG. 4A, except that the third limiter 420 does not receive a bounded reference angle (e.g., the bounded reference angle 414, etc.). That is, the output of the third limiter 420 is not based on the output of the fourth limiter 422 (e.g., the angle overlay 408 is not bounded based on the accessed reference angle 412, etc.). In some examples, the third limiter 420 generates the bounded angle overlay 424 (e.g., bounds the angle overlay 408, etc.) based on a speed of the vehicle 100, the dynamics of the vehicle 100 (e.g., a center of mass of the vehicle 100, a weight distribution of the vehicle 100, etc.), an activity of the driver of the vehicle 100 (e.g., a number of inputs by the driver, a torque applied to the steering wheel 206, etc.), and/or another attribute associated with the vehicle 100. For example, the third limiter 420 can generate a rate limit and/or a magnitude limit for the angle overlay 408 and apply (e.g., cap, etc.) the determined rate limit and/or magnitude limit to the angle overlay 408 to generate the bounded angle overlay 424.

In the illustrated example of FIG. 4B, the fourth limiter 422 generates an example bounded reference angle 426. The fourth limiter 422 is similar to the second limiter 403 except that the fourth limiter 422 generates the bounded reference angle 426 based on the bounded angle overlay 424. That is, in the illustrated example of FIG. 4B, the output of the fourth limiter 422 is based on the output of the third limiter 420 (e.g., the accessed reference angle 412 is bounded based on the bounded angle overlay 424, etc.). In other examples, the output of the fourth limiter 422 (e.g., the bounded reference angle 426, etc.) is bounded based on the angle overlay 408. In some examples, the fourth limiter 422 can be implemented by the limit determiner circuitry 310 of FIG. 3, and the limit applier circuitry 314 of FIG. 3.

In some examples, the fourth limiter 422 determines a rate limit based on a rate of change of the bounded angle overlay 424 and applies the rate limit to the accessed reference angle 412 to generate the bounded reference angle 426. For example, the fourth limiter 422 can determine a rate limit in a manner similar to the second limiter 403 of FIG. 4A. In some examples, the fourth limiter 422 modifies the determined rate limit based on the bounded angle overlay 424. In some examples, the fourth limiter 422 determines a rate of change (e.g., a derivative, etc.) of the bounded angle overlay 424. In some such examples, the fourth limiter 422 filters the determined rate of change to smooth the bounded angle overlay 424 and/or to prevent discontinuities in the bounded angle overlay 424. In some examples, the fourth limiter 422 determines the direction (e.g., positive, negative, etc.) of the rate of change of the bounded angle overlay 424. In some such examples, the fourth limiter 422 determines if the rate of change of the bounded angle overlay 424 is greater than the boundary of the rate limit (e.g., a rate boundary, etc.) in the determined direction. If the bounded angle overlay 424 is greater than the boundary of the rate limit in the determined direction (e.g., the rate limit is saturated, etc.), the fourth limiter 422 sets the boundary of the rate limit in the determined direction to a pre-set value (e.g., zero, etc.). If the bounded angle overlay 424 is less than the boundary of the rate limit in the determined direction (e.g., the rate limit is saturated, etc.), the fourth limiter 422 sets the boundary of the rate limit in the determined direction to a difference between the rate boundary and the bounded angle overlay 424. For example, if the rate limit has a 5 degree per second rate boundary in both the left and right directions and the derivative of the bounded angle overlay 424 is 6 degrees per second, the fourth limiter 422 sets the rate boundary in the left direction to 0 degrees per second. Similarly, if the rate limit has a 5 degree per second rate boundary in both the left and right directions and the derivative of the bounded angle overlay 424 is 4 degrees per second, the fourth limiter 422 sets the rate boundary in the left direction to 1 degree per second.

Additionally or alternatively, the fourth limiter 422 determines a magnitude limit based on the bounded angle overlay 424 and applies the magnitude limit to the accessed reference angle 412. For example, the fourth limiter 422 can determine a rate limit in a manner similar to the first limiter 402 of FIG. 4A. In some examples, the fourth limiter 422 modifies the determined magnitude limit based on the bounded angle overlay 424. In some examples, the fourth limiter 422 determines the direction (e.g., positive, negative, etc.) of the bounded angle overlay 424. In some such examples, the fourth limiter 422 determines if the bounded angle overlay 424 is greater than the boundary of the magnitude limit (e.g., a magnitude boundary, etc.) in the determined direction. If the bounded angle overlay 424 is greater than the boundary of the magnitude limit in the determined direction (e.g., the magnitude limit is saturated, etc.), the fourth limiter 422 sets the boundary of the magnitude limit in the determined direction to a pre-set value (e.g., zero, etc.). If the bounded angle overlay 424 is less than the boundary of the magnitude limit in the determined direction (e.g., the magnitude limit is saturated, etc.), the fourth limiter 422 sets the boundary of the magnitude limit in the determined direction to a difference between the magnitude boundary and the bounded angle overlay 424. For example, if the magnitude limit has a 50 degrees magnitude boundary in both the left and right directions and the bounded angle overlay 424 is 52 degrees, the fourth limiter 422 sets the magnitude limit boundary in the left direction to 0 degrees. Similarly, if the magnitude limit has a 50 degree boundary in both the left and right directions and the derivative of the bounded angle overlay 424 is -40 degrees, the fourth limiter 422 sets the magnitude boundary in the right direction to -10 degrees.

The bounding of the accessed reference angle 412 based on the bounded angle overlay 424 prevents unexpected values for the bounded shared-control reference angle 416. For example, if the bounded angle overlay 424 and the bounded reference angle 426 had the same direction, the combination of the bounded angle overlay 424 and the bounded reference angle 426 could result in a shared-control reference angle that exceeds a controllability limit even though both the bounded angle overlay 424 and the bounded reference angle 426 were bounded. Similarly, if the rate of change of the bounded angle overlay 424 and the rate of change of the bounded reference angle 426 had the same direction, the combination of the bounded angle overlay 424 and the bounded reference angle 426 could result in a rate of change in the shared-control reference angle that exceeds a controllability limit even though both the rate of change of the bounded angle overlay 424 and the rate of change of the bounded reference angle 426 were bounded. Modifying the angle overlay limits determined by the first limiter 402 based on the bounded reference angle 426 prevents such unexpectedly large values of the bounded shared-control reference angle 416. That is, by setting the boundaries of the limits in the determined direction to a difference between the boundary and the bounded angle overlay 424 and/or the rate of change thereof or zero, the addition of the bounded angle overlay 424 and the bounded reference angle 426 prevents the bounded shared-control reference angle 416 for exceeding an overall controllability limit for the bounded shared-control reference angle 416 and/or the rate of change thereof.

FIG. 4C is a schematic system diagram of an example third shared-control steering system 428. The second shared-control steering system 418 is similar to the first shared-control steering system 400, except that the second shared-control steering system 418 includes an example fifth limiter 430. In the illustrated example of FIG. 4C, the limiters 402, 403 of FIG. 4A and the limiters 420, 422 of FIG. 4B are absent. That is, in the illustrated example of FIG. 4C, the angle overlay 408 and the accessed reference angle 412 are not bound prior to being input into the combiner 406. In other examples, one or both of the angle overlay 408 and the accessed reference angle 412 are bounded (e.g., the third shared-control steering system 428 includes the second limiter 403 of FIG. 4A, the third shared-control steering system 428 includes the third limiter 420 of FIG. 4B, etc.). In the illustrated example of FIG. 4C, the third shared-control steering system 428 includes the shared-control angle generator 404 of FIG. 4A and the combiner 406 of FIG. 4A, which generates the angle overlay 408 of FIG. 4A and an example shared-control reference angle 432, respectively.

The fifth limiter 430 receives an example shared-control reference angle 432 and outputs an example bounded shared-control reference angle 416. For example, the fifth limiter 430 can determine one or more limit(s) (e.g., a magnitude limit, a rate limit, etc.) for the shared-control reference angle 432 based on a speed of the vehicle 100, a desired controllability of the vehicle 100, the torque applied to the steering wheel 206, the environment of the vehicle 100 (e.g., the road surface, the type of road the vehicle 100 is operating on, the weather of the vehicle 100, the density and/or type of obstructions around the vehicle 100, etc.), and/or other parameters related to the vehicle 100. For example, the fifth limiter 430 can input one or more parameters related to the vehicle 100 into a look-up table, an equation, and/or a relationship curve to determine one or more limit(s) for the shared-control reference angle 432. In some examples, the look-up table, an equation, and/or a relationship curve are determined (e.g., calculated, populated, generated, etc.) via vehicle testing, based on manufacturer’s preferences, based on based on user preferences, and/or the desired performance characteristics of the vehicle 100. It should be appreciated the fifth limiter 430 can determine one or both of a rate limit and a magnitude limit on the shared-control reference angle 432 to determine the bounded shared-control reference angle 416.

In some examples, the fifth limiter 430 determines a rate limit and applies the determined rate limit to the rate of change of the shared-control reference angle 432 to generate the bounded shared-control reference angle 416. For example, the fifth limiter 430 can determine a maximum rate of change in the positive direction (e.g., a leftward rate boundary, a left rate boundary, etc.) and a maximum rate of change in the negative direction (e.g., a rightward rate boundary, a right rate boundary, etc.). In some examples, the rate boundaries for the shared-control reference angle 432 determined by the fifth limiter 430 are the same in the positive direction and the negative direction (e.g., the fifth limiter 430 determines 5 degrees per second as the positive rate boundary and -5 degrees per second as the negative rate boundary, etc.). In other examples, the rate boundaries for the shared-control reference angle 432 determined by the fifth limiter 430 are different in the positive direction and the negative direction (e.g., the fifth limiter 430 determines 0 degrees per second as the positive rate boundary and -5 degrees per second as the negative rate boundary, etc.).

In some examples, after the fifth limiter 430 determines a rate limit for the shared-control reference angle 432, the fifth limiter 430 compares the rate of change of the shared-control reference angle 432 to the boundaries of the determined rate limit and limits (e.g., caps, etc.) the rate of change of the shared-control reference angle 432 if the rate of change of the shared-control reference angle 432 exceeds the rate limit. For example, if the rate limit has a 5 degree per second rate boundary in both the left and right directions and the rate of change of the shared-control reference angle 432 is -6 degrees per second, the limiter 430 limits (e.g., caps, etc.) the rate of change of the shared-control reference angle 432 is to -5 degrees per second. Similarly, if the rate limit has a 5 degree per second rate boundary in both the left and right directions and the rate of change of the shared-control reference angle 432 is -3 degrees per second, the limiter 430 does not change the shared-control reference angle 432.

Additionally or alternatively, the fifth limiter 430 determines a magnitude limit and applies the determined magnitude limit to shared-control reference angle 432 to generate the bounded shared-control reference angle 416. For example, the fifth limiter 430 can determine a maximum magnitude in the positive direction (e.g., a leftward magnitude boundary, etc.) and a maximum magnitude in the negative direction (e.g., a rightward magnitude boundary, etc.). In some examples, the magnitude boundaries for the shared-control reference angle 432 determined by the fifth limiter 430 are the same in the positive direction and the negative direction (e.g., the fifth limiter 430 determines 50 degrees as the positive boundary and -50 degrees as the negative boundary, etc.). In other examples, the magnitude boundaries for the shared-control reference angle 432 determined by the fifth limiter 430 are different in the positive direction and the negative direction (e.g., the fifth limiter 430 determines 0 degrees as the positive magnitude boundary and -50 degrees as the negative magnitude boundary, etc.).

In some examples, after the fifth limiter 430 determines a magnitude limit for the shared-control reference angle 432, the fifth limiter 430 compares the magnitude of the shared-control reference angle 432 to the boundaries of the determined magnitude limit and limits (e.g., caps, etc.) the shared-control reference angle 432 if the shared-control reference angle 432 exceeds the magnitude limit. For example, if the magnitude limit has a 50 degree magnitude boundary in both the left and right directions and the rate of change of the shared-control reference angle 432 is 52 degrees, the limiter 430 limits (e.g., caps, etc.) the shared-control reference angle 432 is to 50 degrees. Similarly, if the rate limit has a 50 degree magnitude boundary in both the left and right directions and the shared-control reference angle 432 is -43 degrees per second, the fifth limiter 430 does not change the shared-control reference angle 432.

Flowcharts representative of example machine readable instructions, which may be executed by programmable circuitry to implement and/or instantiate the steering controller 106 of FIG. 3 and/or representative of example operations which may be performed by programmable circuitry to implement and/or instantiate the steering controller 106 of FIG. 3, are shown in FIGS. 5-7. The machine readable instructions may be one or more executable programs or portion(s) of one or more executable programs for execution by programmable circuitry such as the programmable circuitry 812 shown in the example programmable circuitry platform 800 discussed below in connection with FIG. 8. In some examples, the machine readable instructions cause an operation, a task, etc., to be carried out and/or performed in an automated manner in the real world.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 5-7, many other methods of implementing the example steering controller 106 may alternatively be used. For example, the order of execution of the blocks of the flowchart may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

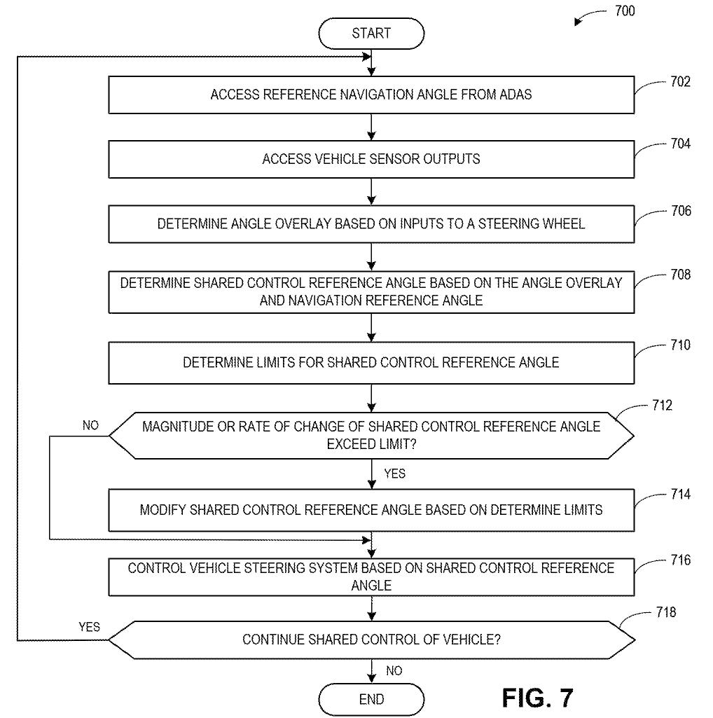

As mentioned above, the example operations of FIG. 7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/ or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 5 is a flowchart representative of example machine readable instructions and/or example operations 500 that may be executed, instantiated, and/or performed by programmable circuitry to generate and apply the bounded shared-control reference angle 416 to the steering system 200 of FIG. 2 via the first shared-control steering system 400 of FIG. 4A. The operations 500 of FIG. 5 are described with reference to the components of the steering controller 106 of FIG. 3. It should be appreciated that the operations 500 of FIG. 5 can additionally or alternatively be implemented by the components of the first shared-control steering system 400 of FIG. 4A. For example, the shared-control angle generator 404 can execute the operations of block 506, the first limiter 402 can execute the operations of blocks 508-531, the second limiter 403 can execute the operations of block 505, and/or the combiner 406 can execute the operations of block 532.

The example machine-readable instructions and/or the example operations 500 of FIG. 5 begin at block 502, at which the ADAS interface circuitry 302 accesses the accessed reference angle 412 of FIG. 4A from the ADAS 102. For example, the ADAS interface circuitry 302 can access (e.g., request, receive, etc.) a reference angle generated by the ADAS 102 via one or more wireless and/or wired connections (e.g., via a CAN bus of the vehicle 100, etc.). At block 504, the sensor interface circuitry 304 accesses the outputs of the vehicle sensor 108. For example, the sensor interface circuitry 304 can receive input from the steering torque sensor 222, the steering wheel angle sensor 224, and/or any other sensors (e.g., a speedometer of the vehicle 100, etc.) via one or more wireless and/or wired connections (e.g., via a CAN bus of the vehicle 100, etc.). In other examples, the sensor interface circuitry 304 can receive some or all of the sensor data from the vehicle sensors 108 via manual input from an operator of the vehicle 100.

At block 505, the limit determiner circuitry 310 bounds the accessed reference angle 412. For example, the limit determiner circuitry 310 can bind the accessed reference angle 412 based on the sensor data accessed during the execution of block 504. For example, the limit determiner circuitry 310 can limit the accessed reference angle 412 based on a speed of the vehicle 100, the dynamic properties of the vehicle 100 (e.g., the weight distribution, the center of mass, a suspension characteristic of the vehicle 100, etc.), and/or the ambient conditions of the vehicle 100. Additionally or alternatively, the limit determiner circuitry 310 can limit the accessed reference angle 412 based a controllability of the vehicle 100 at a given speed. In some examples, the controllability of the vehicle 100 is determined via testing (e.g., assessing if a vehicle 100 remains in a lane during testing, etc.),

At block 506, the angle overlay determiner circuitry 306 determines the angle overlay 408 of FIG. 4A based on inputs to the steering wheel 206. For example, the angle overlay determiner circuitry 306 can determine the angle overlay 408 via the process described in conjunction with FIGS. 9-15 of U.S. Patent Application No. 18/491,557. Additionally or alternatively, the angle overlay determiner circuitry 306 can determine the angle overlay 408 via sensor data accessed by the sensor interface circuitry 304. In some such examples, the angle overlay determiner circuitry 306 can determine the angle overlay 408 via the steering wheel angle, the steering wheel torque, and/or one or other received sensor inputs.

At block 508, the limit determiner circuitry 310 determines an angle overlay limit. For example, the limit determiner circuitry 310 can determine a limit on the angle overlay based on a speed of the vehicle 100, an activity level of a driver of the vehicle 100, a torque applied to the steering wheel 206 of the vehicle, a position of the steering system 200 (e.g., a position of the steering wheel 206, a position of the steering gear 210, a position of the steered wheels 218, 220, etc.), and/or other parameters related to the vehicle 100 and/or an environment of the vehicle 100. In some examples, the limit determiner circuitry 310 can determine the angle overlay limit via a relationship curve and/or a look-up table. In some examples, the limit determiner circuitry 310 can determine a rate limit and/or a magnitude limit for the angle overlay 408. In some examples, the limit determiner circuitry 310 can determine a limit with a positive boundary (e.g., a left boundary, etc.) and a negative boundary (e.g., a right boundary, etc.).

At block 510, the limit modifier circuitry 312 determines if the angle overlay limit(s) are to be modified based on a magnitude of the bounded reference angle 414. For example, the limit modifier circuitry 312 can determine to modify the angle overlay limit based on a magnitude of the bounded reference angle 414 if the angle overlay limit includes (e.g., is, etc.) a magnitude limit. If the limit modifier circuitry 312 determines the angle overlay limit is to be modified based on a magnitude of the bounded reference angle 414, the operations 500 advance to block 512. If the limit modifier circuitry 312 determines the angle overlay limit is not to be modified based on a magnitude of the bounded reference angle 414, the operations 500 advance to block 520.

At block 512, the limit modifier circuitry 312 determines the direction of the bounded reference angle 414. For example, the limit modifier circuitry 312 can determine if the direction of the bounded reference angle 414 is positive (e.g., leftward, etc.) or negative (e.g., rightward, etc.). At block 514, the limit modifier circuitry 312 determines if the bounded reference angle 414 is greater than the magnitude boundary of the angle overlay limit in the direction of the bounded reference angle 414. For example, the limit modifier circuitry 312 can compare the magnitude of the bounded reference angle 414 to the magnitude boundary of the angle overlay limit in the direction of the bounded reference angle 414 (e.g., if the bounded reference angle 414 is positive, the bounded reference angle 414 is compared to the positive magnitude boundary of the angle overlay limit, etc.). If the limit modifier circuitry 312 determines the bounded reference angle 414 is greater than the magnitude boundary of the angle overlay limit in the direction of the bounded reference angle 414, the operations 500 advance to block 516. If the limit modifier circuitry 312 determines the bounded reference angle 414 is not greater than the magnitude boundary of the angle overlay limit in the direction of the bounded reference angle 414, the operations 500 advance to block 518. At block 516, the limit modifier circuitry 312 sets the magnitude boundary of the angle overlay limit in the determined direction to zero. At block 518, the limit modifier circuitry 312 sets the magnitude boundary of the angle overlay limit in the determined direction to the difference between the magnitude boundary and the bounded reference angle 414.

At block 520, the limit modifier circuitry 312 determines if the angle overlay limit(s) are to be modified based on a rate of change of the bounded reference angle 414. For example, the limit modifier circuitry 312 can determine to limit the angle overlay limit based on a rate of change of the bounded reference angle 414 if the angle overlay limit includes (e.g., is, etc.) a rate limit. If the limit modifier circuitry 312 determines the angle overlay limit is to be modified based on a rate of change of the bounded reference angle 414, the operations 500 advance to block 522. If the limit modifier circuitry 312 determines the angle overlay limit is not to be modified based on a rate of change of the bounded reference angle 414, the operations 500 advance to block 531.

At block 522, the limiter modifier circuitry 312 determines the rate of change of the bounded reference angle 414. For example, the limiter modifier circuitry 312 can determine the rate of change analytically (e.g., by taking the derivative of the bounded reference angle 414, etc.). In some examples, the limiter modifier circuitry 312 can filter the output of the limiter modifier circuitry 312 to smooth the rate of change (e.g., to ensure the rate of change determined by the limiter modifier circuitry 312 is continuous, etc.). At block 524, the limiter modifier circuitry 312 determines the direction of the rate of change of the bounded reference angle 414. For example, the limit modifier circuitry 312 can determine if the direction of the rate of change of the bounded reference angle 414 is positive (e.g., moving leftward, etc.) or negative (e.g., moving rightward, etc.).

At block 526, the limit modifier circuitry 312 determines if the rate of change of the bounded reference angle 414 is greater than the rate boundary of the angle overlay limit in the direction of the rate of change of the bounded reference angle 414. For example, the limit modifier circuitry 312 can compare the rate of change of the bounded reference angle 414 to the rate boundary of the angle overlay limit in the direction of the rate of change of the bounded reference angle 414 (e.g., if the rate of change of the bounded reference angle 414 is positive, the rate of change of the bounded reference angle 414 is compared to the positive rate boundary of the angle overlay, etc.). If the limit modifier circuitry 312 determines the rate of change of the bounded reference angle 414 is greater than the rate boundary of the angle overlay limit in the direction of the rate of change of the bounded reference angle 414, the operations 500 advance to block 528. If the limit modifier circuitry 312 determines the rate of change of the bounded reference angle 414 is not greater than the boundary of the angle overlay limit in the direction of the bounded reference angle 414, the operations 500 advance to block 530. At block 528, the limit modifier circuitry 312 sets the rate boundary of the angle overlay limit in the determined direction to zero. At block 530, the limit modifier circuitry 312 sets the rate boundary of the angle overlay limit in the determined direction to the difference between the rate boundary and the rate of change of bounded reference angle 414.

At block 531, the limit applier circuitry 314 modifies the angle overlay 408 based on the angle overlay limit to generate the bounded angle overlay 410. For example, the limit applier circuitry 314 can apply a determined rate limit to the angle overlay 408 by limiting (e.g., capping, etc.) the rate of change of the angle overlay 408 to the boundary of the rate limit associated with the direction of the rate of change of the angle overlay 408. Additionally or alternatively, the limit applier circuitry 314 can apply a determined magnitude limit to the angle overlay 408 by limiting (e.g., capping, etc.) the value of the angle overlay 408 to the boundary of the magnitude limit associated with the direction of the angle overlay 408. In some examples, the limit applier circuitry 314 can deactivate the ADAS 102 if the rate of change and/or magnitude of the angle overlay 408 exceeds a determined limit.

At block 532, the reference angle determiner circuitry 308 determines the bounded shared-control reference angle 416 based on the bounded angle overlay 410 and the bounded reference angle 414. For example, the reference angle determiner circuitry 308 determines the bounded shared-control reference angle 416 for navigation of the vehicle 100 based on the bounded angle overlay 410 determined by the limiter applier circuitry 314 and the bounded reference angle 414 accessed by the ADAS interface circuitry 302 of FIG. 3. For example, the reference angle determiner circuitry 308 can determine the bounded shared-control reference angle 416 via the process described in conjunction with FIG. 6 of U.S. Patent Application No. 18/491,557. In other examples, the reference angle determiner circuitry 308 can determine the bounded shared-control reference angle 416 in any other suitable manner.

At block 534, the steering interface circuitry 316 controls the vehicle steering system based on the bounded shared-control reference angle 416. For example, the steering interface circuitry 316 can convert the bounded shared-control reference angle 416 into a torque request based on the current position of the steering gear 210 of FIG. 2. In some such examples, the steering interface circuitry 316 can determine the torque request based on analytic calculations, a relationship curve, and/or a look-up table. In some examples, the steering interface circuitry 316 can cause the steering motor 214 of FIG. 2 to apply a torque to the steering gear 210 to cause a corresponding change in vehicle navigation based on the bounded shared-control reference angle 416.

At block 536, the ADAS interface circuitry 302 determines if shared control of the vehicle 100 is to continue. For example, the ADAS interface circuitry 302 can determine that shared control is not to continue if the ADAS 102 is deactivated (e.g., via a command by a driver of the vehicle 100, automatically, etc.) and/or if the operation of the vehicle 100 ends (e.g., an engine of the vehicle 100 is turned off, the vehicle 100 is shifted into park, etc.). If shared control is to continue, the operations 500 return to block 502. If shared control is not to continue, the operations 500 end. It should be appreciated that the operations 500 may be repeated continuously while the vehicle 100 is in a driver assist mode (e.g., the ADAS 102 is deactivated, etc.).

FIG. 6 is a flowchart representative of example machine readable instructions and/or example operations 500 that may be executed, instantiated, and/or performed by programmable circuitry to generate and apply the bounded shared-control reference angle 416 to the steering system 200 of FIG. 2 via the second shared-control steering system 418 of FIG. 4B. It should be appreciated that the operations 600 of FIG. 6 can additionally or alternatively be implemented by the components of the second shared-control steering system 418 of FIG. 4B. For example, the shared-control angle generator 404 can execute the operations of block 605, the third limiter 420 can execute the operations of block 606, the fourth limiter 422 can execute the operations of blocks 608-631, and/or the combiner 406 can execute the operations of block 632.

The example machine-readable instructions and/or the example operations 600 of FIG. 6 begin at block 602, at which the ADAS interface circuitry 302 accesses an accessed reference angle 412 from the ADAS 102. For example, the ADAS interface circuitry 302 can access the accessed reference angle 412 of FIG. 4B in the manner described in conjunction with the execution of block 502 of FIG. 5. At block 604, the sensor interface circuitry 304 accesses the outputs of the vehicle sensor 108. For example, the sensor interface circuitry 304 can access the accessed reference angle 412 in the manner described in conjunction with the execution of block 504 of FIG. 5. At block 605, the angle overlay determiner circuitry 306 determines the angle overlay 408 of FIG. 4A based on inputs to the steering wheel 206. For example, the angle overlay determiner circuitry 306 can determine the angle overlay 408 in the manner described in conjunction with the execution of block 506 of FIG. 5.

At block 606, the limit determiner circuitry 310 determines the limit(s) for the angle overlay 408. For example, the limit determiner circuitry 310 can determine the limits for the angle overlay 408 in the manner described in conjunction with block 508 of FIG. 5. At block 608, the limit determiner circuitry 310 determines the limits for the accessed reference angle 412. For example, the limit determiner circuitry 310 can determine the limits in the manner described in conjunction with the execution of block 505 of FIG. 5. In some such examples, the limit determiner circuitry 310 can determine a rate limit and/or a magnitude limit for the accessed reference angle 412. In some such examples, each of the limits determined by the limit determiner circuitry 310 has a positive (e.g., leftward, etc.) and a negative (e.g., rightward, etc.) boundary.

At block 610, the limit modifier circuitry 312 determines if the reference angle limit(s) are to be modified based on a magnitude of the bounded angle overlay 424. For example, the limit modifier circuitry 312 can determine to modify the reference angle limit based on a magnitude of the bounded angle overlay 424 if the reference angle limit includes (e.g., is, etc.) a magnitude limit. If the limit modifier circuitry 312 determines the reference angle limit is to be modified based on a magnitude of the bounded angle overlay 424, the operations 600 advance to block 612. If the limit modifier circuitry 312 determines the reference angle limit is not to be modified based on a magnitude of the bounded angle overlay 424, the operations 600 advance to block 620.

At block 612, the limit modifier circuitry 312 determines the direction of the bounded angle overlay 424. For example, the limit modifier circuitry 312 can determine if the direction of the bounded angle overlay 424 is positive (e.g., leftward, etc.) or negative (e.g., rightward, etc.). At block 614, the limit modifier circuitry 312 determines if the bounded angle overlay 424 is greater than the magnitude boundary of the reference angle limit in the direction of the bounded angle overlay 424. For example, the limit modifier circuitry 312 can compare the magnitude of the bounded angle overlay 424 to the magnitude boundary of the reference angle limit in the direction of the bounded angle overlay 424 (e.g., if the bounded angle overlay 424 is positive, the bounded angle overlay 424 is compared to the positive boundary of the limit of the reference angle, etc.). If the limit modifier circuitry 312 determines the bounded angle overlay 424 is greater than the magnitude boundary of the reference angle limit in the direction of the bounded angle overlay 424, the operations 600 advance to block 616. If the limit modifier circuitry 312 determines the bounded angle overlay 424 is not greater than the magnitude boundary of the reference angle limit in the direction of the bounded angle overlay 424, the operations 600 advance to block 618. At block 616, the limit modifier circuitry 312 sets the magnitude boundary of the reference angle limit in the determined direction to zero. At block 616, the limit modifier circuitry 312 sets the magnitude boundary of the reference angle limit in the determined direction to the difference between the magnitude boundary of the reference angle limit and the bounded angle overlay 424.

At block 620, the limit modifier circuitry 312 determines if the reference angle limit(s) are to be modified based on a rate of change of the bounded angle overlay 424. For example, the limit modifier circuitry 312 can determine to modify the reference angle limit based on a rate of change of the bounded angle overlay 424 if the reference angle limit includes (e.g., is, etc.) a rate limit. If the limit modifier circuitry 312 determines the reference angle limit is to be modified based on a rate of change of the bounded angle overlay 424, the operations 600 advance to block 622. If the limit modifier circuitry 312 determines the reference angle limit is not to be modified based on a rate of change of the bounded angle overlay 424, the operations 600 advance to block 632.

At block 622, the limit modifier circuitry 312 determines the rate of change of the bounded angle overlay 424. For example, the limit modifier circuitry 312 can determine the rate of change analytically (e.g., by taking the derivative of the bounded angle overlay 424, etc.). In some examples, the limit modifier circuitry 312 can filter the bounded angle overlay 424 to smooth the rate of change (e.g., to ensure the rate of change determined by the limit modifier circuitry 312 is continuous, etc.). At block 624, the limit modifier circuitry 312 determines the direction of the rate of change of the bounded angle overlay 424. For example, the limit modifier circuitry 312 can determine if the direction of the rate of change of the bounded angle overlay 424 is positive (e.g., moving leftward, etc.) or negative (e.g., moving rightward, etc.).

At block 626, the limit modifier circuitry 312 determines if the rate of change of the bounded angle overlay 424 is greater than the rate boundary of the reference angle limit in the direction of the rate of change of the bounded angle overlay 424. For example, the limit modifier circuitry 312 can compare the rate of change of the bounded angle overlay 424 to the rate boundary of the reference angle limit in the direction of the rate of change of the angle overlay (e.g., if the rate of change of the bounded angle overlay 424 is positive, the rate of change of the bounded angle overlay 424 is compared to the positive boundary of the reference angle, etc.). If the limit modifier circuitry 312 determines the rate of change of the bounded angle overlay 424 is greater than the rate boundary of the reference angle limit in the direction of the rate of change of the bounded angle overlay 424, the operations 600 advance to block 628. If the limit modifier circuitry 312 determines the rate of change of the bounded angle overlay 424 is not greater than the rate boundary of the reference angle limit in the direction of the bounded angle overlay 424, the operations 600 advance to block 630. At block 628, the limit modifier circuitry 312 sets the rate boundary of the reference angle limit in the determined direction to zero. At block 630, the limit modifier circuitry 312 sets the rate boundary of the reference angle limit in the determined direction to the difference between the rate boundary of the reference angle limit and the rate of change of the bounded angle overlay 424.

At block 631, the limit applier circuitry 314 modifies the reference angle 412 based on the reference angle limit(s) to generate the bounded reference angle 414. For example, the limit applier circuitry 314 can apply a determined rate limit to the reference angle 412 by capping the rate of change of the reference angle 412 to the boundary of the rate limit associated with the direction of the rate of change of the reference angle 412. Additionally or alternatively, the limit applier circuitry 314 can apply a determined magnitude limit to the reference angle 412 by capping the value of the reference angle 412 to the boundary of the magnitude limit associated with the direction of the reference angle 412. In some examples, the limit applier circuitry 314 can deactivate the ADAS 102 if the rate of change and/or magnitude of the reference angle 412 exceeds a determined limit.

At block 632, the reference angle determiner circuitry 308 determines the bounded shared-control reference angle 416 based on the bounded angle overlay 410 and the bounded reference angle 414. For example, the reference angle determiner circuitry 308 can determine the bounded shared-control reference angle 416 in the manner described in conjunction with block 532 of FIG. 5. At block 634, the steering interface circuitry 316 controls the steering system 200 based on the bounded shared-control reference angle 416. For example, the steering interface circuitry 316 can control the steering system 200 based on the bounded shared-control reference angle 416 in the manner described in conjunction with block 534 of FIG. 5. At block 636, the ADAS interface circuitry 302 determines if shared control of the vehicle 100 is to continue. For example, the ADAS interface circuitry 302 can determine that shared control is not to continue if the ADAS 102 is deactivated (e.g., via a command by a driver of the vehicle 100, automatically, etc.) and/or if the operation of the vehicle 100 ends (e.g., an engine of the vehicle 100 is turned off, the vehicle 100 is shifted into park, etc.). If shared control is to continue, the operations 600 return to block 602. If shared control is not to continue, the operations 600 end. It should be appreciated that the operations 600 may be repeated continuously while the vehicle 100 is in a driver assist mode (e.g., the ADAS 102 is deactivated, etc.).

FIG. 7 is a flowchart representative of example machine readable instructions and/or example operations 700 that may be executed, instantiated, and/or performed by programmable circuitry to generate and apply the bounded shared-control reference angle 416 to the steering system 200 of FIG. 2 via the third shared-control steering system 428 of FIG. 4C. It should be appreciated that the operations 700 of FIG. 7 can additionally or alternatively be implemented by the components of the third shared-control steering system 428 of FIG. 4C. For example, the shared-control angle generator 404 can execute the operations of block 706, the fifth limiter 430 can execute the operations of blocks 708-714, and/or the combiner 406 can execute the operations of block 632.

The example machine-readable instructions and/or the example operations 700 of FIG. 7 begin at block 702, at which the ADAS interface circuitry 302 accesses the accessed reference angle 412 from the ADAS 102. For example, the ADAS interface circuitry 302 can access the accessed reference angle 412 of FIG. 4C in the manner described in conjunction with the execution of block 502 of FIG. 5. At block 704, the sensor interface circuitry 304 accesses the outputs of the vehicle sensor 108. For example, the sensor interface circuitry 304 can access the accessed reference angle 412 in the manner described in conjunction with the execution of block 504 of FIG. 5. At block 706, the angle overlay determiner circuitry 306 determines the angle overlay 408 of FIG. 4A based on inputs to the steering wheel 206. For example, the angle overlay determiner circuitry 306 determines the angle overlay 408 in the manner described in conjunction with the execution of block 506 of FIG. 5.

At block 708, the reference angle determiner circuitry 308 determines the shared-control reference angle 432 based on the angle overlay 408 and the accessed reference angle 412. For example, the reference angle determiner circuitry 308 can determine the shared-control reference angle 432 in the manner described in conjunction with block 532 of FIG. 5. In other examples, the angle overlay 408 and/or the accessed reference angle 412 can be modified (e.g., limited, bound, etc.) prior to the execution of block 708. For example, some or all of the operations 500 of FIG. 5 and/or the operations 600 of FIG. 6 can be performed to limit the angle overlay 408 and the accessed reference angle 412. In some such examples, the reference angle determiner circuitry 308 determines the shared-control reference angle 432 based on the bounded angle overlay 410 of FIG. 4A and/or the bounded reference angle 414 of FIG. 4B.

At block 710, the limit determiner circuitry 310 determines limits for the shared-control reference angle 432. For example, the limit determiner circuitry 310 can determine a rate limit and/or a magnitude limit for the shared-control reference angle 432. In some examples, the shared-control reference angle 432 limits can be determined based on a speed of the vehicle 100, the torque applied to the steering wheel 206, the environment of the vehicle 100 (e.g., the road surface, the type of road the vehicle 100 is operating on, the weather of the vehicle 100, the density and/or type of obstructions around the vehicle 100, etc.), and/or other parameters related to the vehicle 100. In some examples, the limit determiner circuitry 310 can determine a magnitude and/or rate limit for the limit determiner circuitry 310 via a look-up table and/or relationship curve. In some examples, the loop-up table and/or relationship curve used by the limit determiner circuitry 310 is populated via vehicle testing, based on manufacturer preferences, based on user preferences, and/or the desired performance characteristics of the vehicle 100.

At block 712, the limit applier circuitry 314 determines if the magnitude and/or rate of change of the shared-control reference angle 432 exceeds the limits determined during the execution of block 710. For example, the limit applier circuitry 314 can determine a rate of change of the shared-control reference angle 432 (e.g., based on immediately previous magnitudes of the angle overlay 408, etc.) and compare the rate of change to a rate limit determined during the execution of block 710. Additionally or alternatively, the limit applier circuitry 314 can compare the magnitude of the shared-control reference angle 432 to the magnitude limit determined during the execution of block 710. If the limit applier circuitry 314 determines the magnitude and/or rate of change of the shared-control reference angle 432 exceeds one or more of the limits, the operations 700 advance to block 714. If the limit applier circuitry 314 determines the magnitude and/or rate of change of the shared-control reference angle 432 does not exceed one or more of the limits, the operations 700 advance to block 716.

At block 714, the limit applier circuitry 314 modifies the shared-control reference angle 432 based on the limit to generate the bounded shared-control reference angle 416. For example, the limit applier circuitry 314 can apply a determined rate limit to the shared-control reference angle 432 by capping the rate of change of the shared-control reference angle 432 to the determined rate limit. Additionally or alternatively, the limit applier circuitry 314 can apply a determined magnitude limit to the shared-control reference angle 432 by capping the absolute value of the angle overlay 408 to the determined magnitude limit. In some examples, the limit applier circuitry 314 can deactivate the ADAS 102 if the rate of change and/or magnitude of the shared-control reference angle 432 exceeds a determined limit.

At block 716, the steering interface circuitry 316 controls the steering system 200 based on the bounded shared-control reference angle 416. For example, the steering interface circuitry 316 can control the steering system 200 based on the bounded shared-control reference angle 416 in the manner described in conjunction with block 534 of FIG. 5. At block 718, the ADAS interface circuitry 302 determines if shared control of the vehicle 100 is to continue. For example, the ADAS interface circuitry 302 can determine that shared control is not to continue if the ADAS 102 is deactivated (e.g., via a command by a driver of the vehicle 100, automatically, etc.) and/or if the operation of the vehicle 100 ends (e.g., an engine of the vehicle 100 is turned off, the vehicle 100 is shifted into park, etc.). If shared control is to continue, the operations 700 return to block 702. If shared control is not to continue, the operations 700 end. It should be appreciated that the operations 700 may be repeated continuously while the vehicle 100 is in a driver assist mode (e.g., the ADAS 102 is deactivated, etc.).

FIG. 8 is a block diagram of an example programmable circuitry platform 800 structured to execute and/or instantiate the example machine-readable instructions and/or the example operations of FIG. 7 to implement the steering controller 106 of FIG. 3. The programmable circuitry platform 800 can be, for example, a server, a personal computer, a workstation, a self-learning machine (e.g., a neural network), a mobile device (e.g., a cell phone, a smart phone, a tablet such as an iPad^{TM}), a personal digital assistant (PDA), an Internet appliance, a DVD player, a CD player, a Blu-ray player, a gaming console, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the ADAS interface circuitry 302, the sensor interface circuitry 304, the angle overlay determiner circuitry 306, the reference angle determiner circuitry 308, the limit determiner circuitry 310, the limiter modified circuitry 312, the limit applier circuitry 314, and the steering interface circuitry 316.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, a CAN or CANFD connection, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIG. 7, may be stored in the mass storage device 828, in the volatile memory 814, in the non-volatile memory 816, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real-world imperfections as will be understood by persons of ordinary skill in the art. For example, “approximately” and “about” may indicate such dimensions may be within a tolerance range of +/- 10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time + 1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that adjust the steering wheel angle of a shared-control ADAS. Examples disclosed herein prevent intendedly large responses in shared-control ADAS. Disclosed systems, apparatus, articles of manufacture, and methods are accordingly directed to one or more enhancement(s) in the operation of a machine such as a computer or other electronic and/or mechanical device.

Example methods and apparatus for shared steering control for driver assist vehicles are disclosed herein. Further examples and combinations thereof include the following:

Example 1 includes a vehicle including a user interface, a driver-assistance system to generate a first reference angle, and a controller to determine an angle overlay based on an input to the user interface, determine an angle overlay limit based on the first reference angle, modify the angle overlay based on the angle overlay limit to generate a modified angle overlay, determine a second reference angle based on the modified angle overlay and the first reference angle, and control the vehicle based on the second reference angle.

Example 2 includes the vehicle of example 1, wherein the angle overlay limit is a rate limit.

Example 3 includes the vehicle of example 2, wherein the angle overlay limit is a first angle overlay limit and the controller is to determine the first angle overlay limit by determining a second angle overlay limit, the second angle overlay limit defining a first rate boundary in a first direction and a second rate boundary in a second direction, determining a derivative of the first reference angle, the derivative having the first direction, and determining a third rate boundary of the first angle overlay limit by subtracting the derivative from the first rate boundary, the third rate boundary in the first direction, the first angle overlay limit having the second rate boundary in the second direction.

Example 4 includes the vehicle of example 3, wherein the controller determines the second angle overlay limit based on a driver activity and a speed of the vehicle.

Example 5 includes the vehicle of example 3, further the controller is further to, after determining the derivative is greater than the first rate boundary, set the first rate boundary to zero.

Example 6 includes the vehicle of any one or more of examples 1-5, wherein the angle overlay limit is a magnitude limit.

Example 7 includes the vehicle of example 6, wherein the angle overlay limit is a first angle overlay limit and the controller is to determine the first angle overlay limit by determining a second angle overlay limit, the second angle overlay limit defining a first magnitude boundary in a first direction and a second magnitude boundary in a second direction, and determining a third magnitude boundary of the first angle overlay limit by subtracting the first reference angle from the first magnitude boundary, the third magnitude boundary in the first direction, the first angle overlay limit having the second magnitude boundary in the second direction.

Example 8 includes a vehicle including a user interface, a driver-assistance system to generate a first reference angle, and a controller to determine an angle overlay based on an input to the user interface, determine a reference angle limit based on the angle overlay, modify the first reference angle based on the reference angle limit to generate a second reference angle, determine a third reference angle based on the angle overlay and the second reference angle, and control the vehicle based on the third reference angle.

Example 9 includes the vehicle of example 8, wherein the reference angle limit is a rate limit.

Example 10 includes the vehicle of example 9, wherein the reference angle limit is a first reference angle limit and the controller is to determine the first reference angle limit by determining a second reference angle limit, the second reference angle limit defining a first rate boundary in a first direction and a second rate boundary in a second direction, determining a derivative of the first reference angle, the derivative having the first direction, and determining a third rate boundary of the first reference angle limit by subtracting the derivative from the first rate boundary, the third rate boundary in the first direction, the first reference angle limit having the second rate boundary in the second direction.

Example 11 includes the vehicle of example 10, wherein the driver-assistance system is a path follower (PF) system and the user interface is a steering wheel.

Example 12 includes the vehicle of example 10, further the controller is further to, after determining the derivative is greater than the first rate boundary, set the first rate boundary to zero.

Example 13 includes the vehicle of any one or more of examples 8-12, wherein the reference angle limit is a magnitude limit.

Example 14 includes the vehicle of example 13, wherein the reference angle limit is a first reference angle limit and the controller is to determine the reference angle limit by determining a second reference angle limit, the second reference angle limit defining a first rate boundary in a first direction and a second rate boundary in a second direction, and determining a third rate boundary of the first reference angle limit by subtracting the angle overlay from the first rate boundary, the third rate boundary in the first direction, the first reference angle limit having the second rate boundary in the second direction.

Example 15 includes a vehicle including a user interface, a driver-assistance system to generate a first reference angle, and a controller to determine an angle overlay based on an input to the user interface, determine a second reference angle based on the angle overlay and the first reference angle, determine a reference angle limit, modify the second reference angle based on the reference angle limit to generate a third reference angle, and control the vehicle based on the third reference angle.

Example 16 includes the vehicle of example 15, wherein the controller is determining the reference angle limit based on a speed of the vehicle and a dynamic characteristic of the vehicle.

Example 17 includes the vehicle of any one or more of examples 15-16, wherein the user interface is a steering wheel and the controller is determine the reference angle limit based on a torque applied to the steering wheel.

Example 18 includes the vehicle of any one or more of examples 15-17, wherein the reference angle limit is a magnitude limit.

Example 19 includes the vehicle of any one or more of examples 15-18, wherein the reference angle limit is a rate limit.

Example 20 includes the vehicle of example 19, wherein the reference angle limit is a first reference angle limit and the controller is further to modify the second reference angle based on a second reference angle limit and wherein the second reference angle limit is a magnitude limit.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A vehicle including:
a user interface;
a driver-assistance system to generate a first reference angle; and
a controller to:
determine an angle overlay based on an input to the user interface;
determine an angle overlay limit based on the first reference angle;
modify the angle overlay based on the angle overlay limit to generate a modified angle overlay;
determine a second reference angle based on the modified angle overlay and the first reference angle; and
control the vehicle based on the second reference angle.

2. The vehicle of claim 1, wherein the angle overlay limit is a rate limit.

3. The vehicle of claim 2, wherein the angle overlay limit is a first angle overlay limit and the controller is to determine the first angle overlay limit by:
determining a second angle overlay limit, the second angle overlay limit defining a first rate boundary in a first direction and a second rate boundary in a second direction;
determining a derivative of the first reference angle, the derivative having the first direction; and
determining a third rate boundary of the first angle overlay limit by subtracting the derivative from the first rate boundary, the third rate boundary in the first direction, the first angle overlay limit having the second rate boundary in the second direction.

4. The vehicle of claim 3, wherein the controller determines the second angle overlay limit based on a driver activity and a speed of the vehicle.

5. The vehicle of claim 3, further the controller is further to, after determining the derivative is greater than the first rate boundary, set the first rate boundary to zero.

6. The vehicle of claim 1, wherein the angle overlay limit is a magnitude limit.

7. The vehicle of claim 6, wherein the angle overlay limit is a first angle overlay limit and the controller is to determine the first angle overlay limit by:
determining a second angle overlay limit, the second angle overlay limit defining a first magnitude boundary in a first direction and a second magnitude boundary in a second direction; and
determining a third magnitude boundary of the first angle overlay limit by subtracting the first reference angle from the first magnitude boundary, the third magnitude boundary in the first direction, the first angle overlay limit having the second magnitude boundary in the second direction.

8. A vehicle including:
a user interface;
a driver-assistance system to generate a first reference angle; and
a controller to:
determine an angle overlay based on an input to the user interface;
determine a reference angle limit based on the angle overlay;
modify the first reference angle based on the reference angle limit to generate a second reference angle;
determine a third reference angle based on the angle overlay and the second reference angle; and
control the vehicle based on the third reference angle.

9. The vehicle of claim 8, wherein the reference angle limit is a rate limit.

10. The vehicle of claim 9, wherein the reference angle limit is a first reference angle limit and the controller is to determine the first reference angle limit by:
determining a second reference angle limit, the second reference angle limit defining a first rate boundary in a first direction and a second rate boundary in a second direction;
determining a derivative of the first reference angle, the derivative having the first direction; and
determining a third rate boundary of the first reference angle limit by subtracting the derivative from the first rate boundary, the third rate boundary in the first direction, the first reference angle limit having the second rate boundary in the second direction.

11. The vehicle of claim 10, wherein the driver-assistance system is a path follower (PF) system and the user interface is a steering wheel.

12. The vehicle of claim 10, further the controller is further to, after determining the derivative is greater than the first rate boundary, set the first rate boundary to zero.

13. The vehicle of claim 8, wherein the reference angle limit is a magnitude limit.

14. The vehicle of claim 13, wherein the reference angle limit is a first reference angle limit and the controller is to determine the reference angle limit by:
determining a second reference angle limit, the second reference angle limit defining a first rate boundary in a first direction and a second rate boundary in a second direction; and
determining a third rate boundary of the first reference angle limit by subtracting the angle overlay from the first rate boundary, the third rate boundary in the first direction, the first reference angle limit having the second rate boundary in the second direction.

15. A vehicle including:
a user interface;
a driver-assistance system to generate a first reference angle; and
a controller to:
determine an angle overlay based on an input to the user interface;
determine a second reference angle based on the angle overlay and the first reference angle;
determine a reference angle limit;
modify the second reference angle based on the reference angle limit to generate a third reference angle; and
control the vehicle based on the third reference angle.

16. The vehicle of claim 15, wherein the controller is determine the reference angle limit based on a speed of the vehicle and a dynamic characteristic of the vehicle.

17. The vehicle of claim 15, wherein the user interface is a steering wheel and the controller is determine the reference angle limit based on a torque applied to the steering wheel.

18. The vehicle of claim 15, wherein the reference angle limit is a magnitude limit.

19. The vehicle of claim 15, wherein the reference angle limit is a rate limit.

20. The vehicle of claim 19, wherein the reference angle limit is a first reference angle limit and the controller is further to modify the second reference angle based on a second reference angle limit and wherein the second reference angle limit is a magnitude limit.
